(19) United States
(12) Patent Application Publication
(10) Pub. No.: US 2007/0104899 A1
(43) Pub. Date: May 10, 2007

(54) Process for printing images on dark surfaces

(75) Inventors: Yossi Pearl, Tel-Aviv (IL); Ofer Ben-Zur, RaAnana (IL)

Correspondence Address: Martin D. Moynihan;PRTSI, Inc., P.O. Box 16446, Arlington, VA, 22215, US

(73) Assignee: Kornit Digital Ltd., Moshav Magshimim (IL)

(21) Appl. No.: 11/588,277

(22) Filed: Oct. 27, 2006

Related U.S. Application Data
(63) Continuation-in-part of application No. 10/461,414, filed on Jun. 16, 2003, now Pat. No. 7,134,749.
(63) Continuation-in-part of application No. PCT/IL05/00558, filed on May 30, 2005.
(63) Continuation-in-part of application No. PCT/IL05/00559, filed on May 30, 2005.
Application No. PCT/IL05/00559 is a continuation-in-part of application No. PCT/IL05/00166, filed on Feb. 10, 2005.
Application No. PCT/IL05/00558 is a continuation-in-part of application No. PCT/IL05/00166, filed on Feb. 10, 2005.
(60) Provisional application No. 60/759,955, filed on Jan. 19, 2006.

(30) Foreign Application Priority Data
May 30, 2004 (IL) 162231
Aug. 11, 2004 (IL) 163459

(51) Int. Cl. B41M 5/50

(52) U.S. Cl. 428/32.24

(57) ABSTRACT

Novel processes for printing high quality, high resolution, multi-color images on darkly colored fibrous or porous materials or other ink absorbing materials, is disclosed. The processes are effected by digitally printing a layer of an opaque, lightly colored ink composition, followed by digitally printing the colored image thereon, and optionally further involve applying a wetting composition prior to and/or subsequent to these printings. Processes utilizing wetting compositions and/or liquid ink compositions which can interact therebetween so as to effect a chemical and/or physical change in one or more of these compositions are further disclosed.

### RELATED APPLICATIONS

This Application is a continuation-in-part of pending U.S. patent application Ser. No. 10/461,414, filed Jun. 16, 2003. This Application is also a continuation-in-part of PCT International Applications Nos. PCT/IL2005/000558 and PCT/IL2005/000559, both filed May 30, 2005, and both of which are continuation-in-part Applications of PCT International Application No. PCT/IL2005/000166, filed Feb. 10, 2005. PCT International Applications Nos. PCT/IL2005/000558 and PCT/IL2005/000559 also claim the benefit of U.S. Provisional Patent Application No. 60/651,230, filed Feb. 10, 2005, and Israel Patent Applications Nos. 163459, filed Aug. 11, 2004 and 162231, filed May 30, 2004. This Application also claims the benefit of U.S. Provisional Patent Application No. 60/759,955, filed Jan. 19, 2006. The teachings of all of the Applications listed hereinabove are incorporated herein in their entirety.

### FIELD AND BACKGROUND OF THE INVENTION

The present invention relates to the field of printing and, more particularly, to novel processes of high-resolution, high-definition multicolor direct printing on dark surfaces such as a dark textile piece.

The ever growing demand for new and stimulating garment and fabric fashion, one of the greatest commercial markets, challenges cutting edge technology to innovate in areas such as fiber materials, weaving and threading, cloth fabrication, dying and post treatment of textile fabrics. Still, the area in which technology can contribute the most is in the merging of textile with the limitless world of designer art. Hence, most promising is the area of textile printing of designer's art, which is still not fulfilled satisfactorily by the present technologies.

There are several technical and logistic challenges on the way to accomplishing the goal of high-resolution, high-definition art printing unique to textile printing, especially when the fabric is used for a garment and the textile piece is of any color and shade, and more so when the textile piece is of a dark color or shade. Moreover, the printed image should withstand recurrent washings, stretching and other conditions of typical use of a garment while maintaining its color related qualities. It is further desired that the printed area would have a similar texture and pleasant feel of the original fabric. Finally, the process should to be reproducible, adapted for mass production and cost-effective while maintaining the quality of the printed image.

When considering the quality of a printed color image or design, especially in the case of artwork and photorealistic images, there are criteria which can be used to parameterize such terms as vividness, high-definition or colorfulness. Color space parameters can therefore be used to define the quality of a printed image and thus be used to compare between various final products of printed color images. Color space is a system for describing color numerically, based on one or more color models. A color model is an abstract mathematical model describing the way colors can be represented as tuples of numbers (sets of variables), typically as three or four values or color components, such as, for example, Red-Green-Blue (RGB) and Cyan-Magenta-Yellow-blacK (CMYK) which are two of the most frequently used color models. The choice for using one model or another depends on the uses and context thereof. For example, for a transmissive/reflective electronic devices, such as scanners and computer monitors, the most widely used color model is RGB, whereby CMYK is the model of choice for color printing, and YUV for video and TV. However, a color model with no associated mapping function to an absolute color space is a more or less arbitrary color system with little connection to the requirements of any given application. For that context other color models were developed, for example, HSB model which uses hue, saturation and brightness (also known as HSV), HSL (hue, saturation, lightness/luminance), also known as HLS or HSI (hue, saturation, intensity) which is quite similar to HSV, with “lightness” replacing “brightness”, and CIE-Lab model which uses lightness (L) and values on red-green (a) and blue-yellow (b) axes (CIE stands for Commission Internationale de l'Eclairage or the International Commission on Illumination). These color models are very useful to define colors, color richness and diversity, and therefore can be used effectively to assess the quality of a printed image in absolute and thus comparable numeric variables and terms. When formally defining a color space, the usual reference standard is the CIE-Lab color space, which was specifically designed to encompass all colors the average human can see, and is the most accurate color space. Adding a certain mapping function between the color model and a certain reference color space results in a definite “footprint” within the reference color space. This “footprint” is known as a gamut, and, in combination with the color model, defines a new color space. The gamut analysis of a high-quality image will produce a wider and more continuous and densely filled volume on a three dimensional color space represented, for example, by the CIE-Lab color model, wherein a similar analysis of a low-quality color image will produce a smaller, partially filled (discontinuous) volume is the chosen color space.

To date, several technologies are typically used for printing color images on textile surfaces. These include, for example, mold block techniques such as rotogravure and flexographic printing, screen printing, and dye sublimation. However, the requirements set forth above are only partially met with these techniques.

The presently used printing methods therefore fail to meet contemporary demands of the fashion industry by failing to produce high-resolution and photorealistic multicolor images. The disadvantages of these methods generally result from the multi-step processes that are involved, the cost and time-consuming pre-treatment of the fabrics, and, above all, the mediocre results obtained thereby. Moreover, at least some of these methods are limited to certain types of textile surfaces and colorants.

One approach for increasing textile printing speed, quality, versatility and simplicity involves the use of inkjet printing. Since the introduction thereof in the latter half of the 1980s (see, for example, U.S. Pat. Nos. 4,312,007 and 4,380,770), inkjet printers have grown in availability, performance and popularity while dropping significantly in price, mostly due to their reliability, relatively quiet operation, versatility, graphics capability, print quality, and low cost. Moreover, inkjet printers have made possible “on demand” color printing without the need for complicated devices.

An inkjet printer is a printer that places droplets of ink onto a subject surface, so as to create an image. The dots created by the droplets are very small, ranging between 50 to 60 microns in diameter. The dots are positioned precisely, usually by a digital process, with resolutions of up to 1440 over 720 dots per inch (dpi) in common home printers. The dots can have different colors, depending on the number of inks used by the printer and the image requirements, which are combined together to create photo-quality images. An inkjet printing apparatus typically includes an inkjet printing head having a multitude of nozzles that are used to spray droplets of ink, whereby each printing head is typically responsible for spraying a different color ink. Depending on the printing technique used, ink cartridges are available in various combinations, such as separate black and color cartridges, color and black in a single cartridge or a cartridge for each ink color. In some printer models the cartridge and printing head are combined to one unit.

Inkjet printers are capable of printing on a variety of surfaces. For example, commercial inkjet printers can spray directly on a non-flat, curved item such as the label on a glass bottle. For consumer use, there are a number of specialty papers, ranging from adhesive-backed labels or stickers to business cards and brochures.

When the desired surface is a garment or another textile fabric surface, digital inkjet technology is probably the most favorable technique for designer art and image creation. It is relatively cheap and versatile, yet can provide high resolution multicolor and photorealistic images, as many households experience with their low cost, high resolution inkjet home computer printers.

The presently available inks for inkjet printing include aqueous-based inks and non-aqueous solvent-based inks. Aqueous-based inks are typically composed of water and a colorant, usually a dye or pigment dispersion, and may further contain a number of additives for imparting certain features to the ink (e.g., improved stability and flow, feather resistance, and the like). Non-aqueous solvent-based inks are typically composed of one or more volatile organic solvents, such as low alcohols, glycol ethers, low alkanes and the like, and a colorant.

The image obtained by an inkjet process on high quality inkjet paper has relatively good quality, particularly in view of the cost and effort put in the process.

Generally in imaging systems, projecting or imprinting, colors can be mixed in different ways to generate any desired hue at any desired level of brightness and saturation, as it is perceived by the human eye, by using a small number of primary colors. When light interacts with the surface of an object it can be partially reflected or partially penetrate the matter which refracts the light. In the case of transparent materials and visible light, all these physical phenomena occur to a certain level depending on the material of the object and the wavelength of the incident light. When white light (a phrase used in the context of the present invention to describe light containing all wavelengths in the visible continuous spectrum such as day light) strikes a semi-transparent object, light of certain wavelength(s) is reflected from the surface of the object, light of certain wavelength(s) is absorbed by the object and light of other wavelength(s) passes through the material. Therefore different colors are produced in this event, when light of certain wavelengths is subtracted from the white light. Colors can also be added to one another, as is the case in all image projecting devices such as a television screen, and other transparent material systems such as the atmosphere, but in everyday life most colors are subtractive colors, produced when white light is only partially and selectively reflected from a colored object, in terms of intensity and wavelength (color).

The human eye includes cells, called cones, which are sensitive to light of a particular range of wavelengths, and respond to blue light, green light and red light. All other colors human perceive are combinations of these three colors. When one uses the adjective “green” to describe an object, one typically refers to an object that reflects green and absorbs all other colors. A white object reflects all colors and a black object absorbs all colors.

The mixing method commonly used in printing is known as subtractive primary colors model. Typically an inkjet printing system includes a set of inks, one for each of the primary colors used to create an almost complete spectrum of colors, or color space. The most commonly used in printing is the CMYK color model. The black is referred to as K for key—shorthand for the printing term “key plate” which was used to impress the artistic detail of an image, usually in black ink. C stands for cyan; M stands for magenta and Y stands for yellow.

In the direct printing method such as inkjet printing, the formation of the image is achieved by placing ink drops of the primary colors on the surface at different adjacent sites as discrete, physically non-mixed drops.

In the subtractive color printing process, colors are produced, for example, from the primary colors cyan, magenta and yellow, using a process of subtraction or filtering. The color perceived is not generated directly by the object's surface alone but rather is the result of the surrounding light being reflected off the printed ink surface, or transmitted to the object's surface and reflected back to the viewer through the ink. The ink absorbs some, but not all, of the light wavelengths, reflecting or allowing transmission of the rest. As a result, the ink film serves as a filter that selectively subtracts certain colors.

In inkjet printing, each drop plays the role of a single distinct colored object according to the primary color ink it is made of. Due to the small size and spatial proximity, several drops of different color inks may be perceived by the human eye as one combined subtractive or filtered color.

Opaque inks reflect light wavelengths, while transparent inks transmit light wavelengths to the object's surface. Therefore, when using transparent inks, the color of object's surface has a principal influence on the perceived color, and thus is usually opaque white, or at least lightly colored. In that case, the viewer receives the reflected light from the substrate. For example, if a white substrate is painted with pure blue transparent ink, the ink layer absorbs the ambient light, allowing only the blue light to be transmitted to the substrate. The blue light is then reflected by the opaque white substrate, back through the ink and into the viewer's eyes, and perceived by the viewer as blue color.

These printing approaches are satisfactory for printing on white and very light colored surfaces (requiring some color augmentation adjustment), as the color of the background (the color of the surface) participates in the formation of the final perceived color by being visible between the ink drops or dots and/or through ink drops or dots and providing the reflective background from which light is being transmitted back through the transparent ink drops. However, colored images on colored backgrounds and especially on dark colored surfaces can rarely be distinguished. This is due to the fact that light impinging on the dark surface is not reflected towards the eyes of the viewer. Rather, if the surface base color is dark, then transmitted light will be absorbed and not reflected by the substrate, and the viewer will not see the light. Thus, direct printing on dark surfaces such as garments is not possible using presently available digital devices, such as color copiers, inkjet printers, laser printers and the like.

Any attempt to use the presently available printing techniques, which are based on the surface of the substrate being white or very lightly-colored, will result in a color-skewed and dim image.

U.S. Pat. No. 6,667,093 by Yuan et al., and U.S. Patent Application No. 20040100546 by Horvarth disclose a system for transferring images produced by an ink jet printer onto darkly-colored textile surfaces by means of a multi-layer structure containing meltable thermoplastics. The method comprises a backing substrate; a melt transfer layer applied to the backing substrate; an ink absorption meltable layer into which fine particles of a filler material capable of ink absorption are embedded; an ink-permeable contrast layer comprising a light-colored or white pigment; and a second melt transfer layer being porous and permeable to ink.

U.S. Application No. 20050048230 and U.S. Pat. No. 6,884,311 disclose an image transfer sheet comprising a release layer and a polymer layer, one of which comprises titanium oxide or other white pigment. This method for transferring an image to a colored substrate, includes providing an image transfer sheet comprising a release layer and an image-imparting layer that comprises a polymer wherein one or more of the image-imparting layer and the release layer comprise titanium oxide or other white pigment or luminescent pigment; contacting the image transfer sheet to the colored substrate; and applying heat to the image transfer sheet so that an image is transferred from the image transfer sheet to the colored substrate.

Like other similar techniques wherein the image is created off the fabric on a special paper or decal containing an adhesion agent layer, this cumbersome multi-layered and multi-stepped process first produces a relatively thick, stiff and crack-prone sticker of the inkjet printed image which is then applied/transferred to the surface of the textile subject by heat and/or pressure. The resulting image tends to crack upon usage, has an unpleasant feel and seals the fabric from “breathing”.

The image obtained by an ink-jet process on high quality pretreated inkjet paper has relatively good quality, particularly in view of the cost and effort put in the process. However, a major technical obstacle which still impedes ink-jet printing stems from the absorptive nature of certain untreated substrate material.

U.S. application Ser. No. 10/461,414 having Publication No, 20040252173 (recently granted), by the present inventors, of which this application is a continuation-in-part and which is incorporated by reference as if fully set forth herein, teaches a method and an apparatus for color printing on a dark textile piece which includes digitally printing, by means of an inkjet printer head, an opaque white ink layer directly onto a dark textile piece, and digitally printing a colored image on the white ink layer. One of the main principles in this method is the digital printing of the white ink layer, which is performed such that the white ink layer substantially covers, without exceeding, the designed area of the next to be printed colored image, and further such that the white ink layer and the colored image are substantially coextensive. All the printing steps in this method are performed by essentially using conventional inkjet printing techniques.

While, as discussed hereinabove, inkjet printing is highly advantageous for printing color images on various surfaces, including textile surfaces, it is often still limited when used to print images on absorptive surfaces. While printing on absorptive surfaces such as, for example, textiles, the liquid inkjet ink is often uncontrollably absorbed therein.

Thus, using inkjet printing techniques for printing on absorptive surfaces such as textiles is associated with various limitations. Typically inkjet printed images on textiles are of low quality and often smudge upon handling, exhibit bleeding (the intrusion of one color into an adjacent color) and infiltration (the diffusion of the image through the fabric), are moisture sensitive, and are dull, i.e., the colored inks fail to accurately produce the expected hues. Moreover, the printed images are often neither water-fast nor detergent-resistant, resulting in fading of the printed image after washing and further oftentimes fail to meet the demand for pleasant hand feel. While the textile industry requires that the image be both water-resistant and detergent-resistant, that the colors and hues would be as vivid as possible, that the colorant of the ink would adhere tenaciously to the substrate, and that the desirable hand properties of the substrate would be maintained, there is a widely recognized need for improving the presently utilized inkjet printing techniques so as to accomplish these requirements.

Several techniques are presently known in the art which are aimed at overcoming the limitations associated with digital inkjet printing on textile and other absorptive surfaces. These include, for example, pre-treatment of the fabric prior to the printing process. Thus, U.S. Pat. Nos. 6,291,023, 6,698,874 and 6,840,992, for example, teach coating compositions which are applied on the fabric prior to printing. Albeit, these pre-treatments are not suitable for all fabric materials, use environmentally unfriendly chemicals, are time-consuming and cost-ineffective.

Other attempts aimed at achieving a high-quality, long-lasting image, involve protection of the image, once applied on the surface, by a protective coating, as taught, for example, in U.S. Pat. No. 6,626,530. These attempts, however, reduce the simplicity and cost-effectiveness of the process, while resulting in a final product with an unpleasant feel.

Hence, while the prior art teaches various methods for printing images on various surfaces, these techniques, including the most promising technique of inkjet printing, are limited by the ability to create a multicolor, high resolution photorealistic image on textile. Most commonly used techniques are limited to white or lightly colored surfaces, and further suffer from adverse characteristics such as feathering (bleeding) and deep infiltration of the ink when applied on absorptive surfaces and inaccurate placement of the inks due to stray fibers which plagues the end result with blurriness and lack of high definition, in addition to the unpleasant hand-feel (and odor) of pre-treated fabrics and the unpleasant hand-feel and cracking of plasticized colorants.

PCT Application Nos. WO 2005/115089 and WO 2005/115761, by the present inventors, of which this application is a continuation-in-part and which are both incorporated by reference as if fully set forth herein, teach a process, a composition and an apparatus for printing an image on an absorptive surface, such as a textile piece, that includes applying a wetting composition on the surface which is capable of interfering with the engagement of a liquid ink composition with the binding sites of the surface. According to the processes taught in these patent applications, once the wetting composition is applied, the liquid ink composition is applied while the surface is still wet. Using this process, a vivid color image is formed on the absorptive surface. These patent applications, however, fail to address the limitations associated with printing a color image on an absorptive dark surface.

There is thus a widely recognized need for, and it would be highly advantageous to have, a method for printing high-quality and vivid multicolor images on textile and other absorptive surfaces of any color and shade in general and on darkly-colored textile fabrics in particular, devoid of the above limitations.

### SUMMARY OF THE INVENTION

The present inventors have now designed and successfully practiced novel processes for printing an image on dark surfaces. These process which are particularly beneficial for printing multicolor images on dark and absorptive surfaces such as, but not limited to, dark textile fabrics and garments. These processes involve printing of an opaque and lightly colored mask on the surface, so as to modify the light interaction of the surface, and thereafter printing a color image onto this mask. The present inventors have uncovered that such a process can be beneficially performed while utilizing an aqueous-based ink composition for at least one or both of the lightly colored and colored ink compositions and further that by performing the process without curing the lightly colored mask layer, color images with improved quality are obtained.

While further searching for novel methodologies for improving the quality of a printed image on dark and absorptive surfaces, the present inventors have found that by wetting a surface onto which an image is to be printed with a wetting composition that interferes with the engagement of the ink with the surface and thus temporarily modify the surface mechanical, physical and/or chemical characteristics, before and/or after the printing of the lightly colored mask layer, results in high-resolution, high-definition and vivid images, with no bleeding and diffusion of the ink. The present inventors have further found that by adding a property adjusting agent to either the opaque or colored liquid ink compositions or to the wetting composition and adding a property sensitive agent, which promotes the adhesion of the colorant to the substrate upon contacting the property adjusting agent, to any of the wetting or liquid ink compositions which do not have the property adjusting, result in affixing the colorants in the inks to the surface.

Thus, according to one aspect of the present invention there is provided a process of printing a color image on a dark surface, the process includes digitally printing, by means of an inkjet printing head, a layer of a substantially opaque liquid ink composition onto the dark surface; and digitally printing a colored liquid ink composition on the layer of the opaque liquid ink composition, to thereby form the color image, wherein the opaque liquid ink composition is capable of modifying a light interaction of the image.

According to features in preferred embodiments of the invention described below, digitally printing the layer of the opaque liquid ink composition is performed such that the layer of the opaque liquid ink composition substantially covers, without exceeding, the designed area of the colored image and the layer of the opaque liquid ink composition and the color image are substantially coextensive.

According to further features in preferred embodiments of the invention described below, digitally printing the color image is performed without curing the layer of the opaque liquid ink composition.

According to further features in preferred embodiments of the invention described below, the opaque liquid ink composition is a lightly colored ink composition, and preferably the opaque liquid ink composition is substantially white.

According to still further features in the described preferred embodiments digitally printing the layer of the opaque liquid ink composition is effected prior to, concomitant with and/or subsequent to digitally printing the colored liquid ink composition.

According to still further features in the described preferred embodiments each of the opaque liquid ink composition and the colored liquid ink composition independently comprises a colorant and a carrier, and preferably the carrier is an aqueous carrier.

According to still further features in the described preferred embodiments the concentration of the colorant in the opaque liquid ink composition ranges from 0 weight percentages to about 10 weight percentages of the total weight of the composition, and alternatively the concentration of the colorant ranges from about 10 weight percentages to about 25 weight percentages of the total weight of the composition.

According to still further features in the described preferred embodiments each of the opaque liquid ink composition and the colored liquid ink composition, independently, further comprises an additional component selected from the group consisting of an adhesion promoting agent, a viscosity modifying agent, a dispersing agent, a thickening agent, a surface active agent, a surfactant, a polyol, a surface tension modifying agent, a softener, and any combination thereof.

According to still further features in the described preferred embodiments one or more of the opaque liquid ink composition and the colored liquid ink composition comprises a property-adjusting agent and one or more of the opaque liquid ink composition and the colored liquid ink composition which does not comprise the property-adjusting agent comprises a property-sensitive agent, whereas the property-adjusting agent effects a chemical and/or physical change in the property-sensitive agent upon a contact between the opaque liquid ink composition and the colored ink composition, and thereby effects a chemical and/or physical change in the opaque liquid ink composition or the colored liquid ink composition which comprises the property-sensitive agent.

According to still further features in the described preferred embodiments the opaque liquid ink composition comprises the property-adjusting agent and the colored liquid ink composition comprises the property-sensitive agent, such that contacting the opaque liquid ink composition and the colored liquid ink composition effects a chemical and/or physical change in the colored liquid ink composition.

According to still further features in the described preferred embodiments the chemical and/or physical change is selected from the group consisting of solidification, adhesion, thickening, polymerization, sedimentation and cross-linking.

According to still further features in the described preferred embodiments the property is a chemical and/or physical property selected from the group consisting of acidity (pH), ionic strength, solubility, hydrophobicity and electric charge.

According to still further features in the described preferred embodiments the property-adjusting agent is selected from the group consisting of an acid, a base, a salt, a charged polymer, an oxidizing agent, a reducing agent, a radical-producing agent and a cross-linking agent.

According to still further features in the described preferred embodiments the salt is selected from the group consisting of a calcium salt, calcium chloride, calcium acetate, an aluminum salt, aluminum chloride, aluminum sulfate and any combination thereof.

According to still further features in the described preferred embodiments the chemical and/or physical property is acidity, and the property-adjusting agent is an organic acid.

According to still further features in the described preferred embodiments the organic acid is selected from the group consisting of carbonic acid, formic acid, acetic acid, propionic acid, butanoic acid, an α-hydroxy acid, glycolic acid, lactic acid and any combination thereof.

According to still further features in the described preferred embodiments the property-sensitive agent is selected from the group consisting of an adhesion promoting agent, a dispersing agent, a viscosity modifying agent, a thickener agent, a surface tension modifying agent, a surface active agent, a surfactant and a softener.

According to still further features in the described preferred embodiments the concentration of the property-adjusting agent ranges from about 0.5 weight percentages to about 20 weight percentages of the total weight of the composition comprising same.

According to still further features in the described preferred embodiments the concentration of the property-sensitive agent ranges from about 0.5 weight percentages to about 30 weight percentages of the total weight of the composition comprising same.

According to yet another aspect of the present invention there is provided a process of printing a color image on a dark surface, which includes contacting at least a part of the surface with a wetting composition so as to provide a wet part of the surface; digitally printing, by means of an inkjet printing head, a layer of a substantially opaque liquid ink composition directly onto the dark surface; and digitally printing a colored liquid ink composition on the layer of the opaque liquid ink composition and/or the wetting composition, to thereby form the color image, wherein the wetting composition is capable of modifying an interaction of the opaque liquid ink composition with the surface and/or the wetting composition is capable of modifying an interaction of the colored liquid ink composition with the surface and/or with the opaque liquid ink composition; and the opaque liquid ink composition is capable of modifying a light interaction of the image.

According to further features in preferred embodiments of the invention described below, the digitally printing the color image is performed without curing the wetting composition and/or the layer of the opaque liquid ink composition.

According to further features in preferred embodiments of the invention described below, the wetting composition comprises an organic solvent, and preferably the organic solvent is an alcohol.

According to further features in preferred embodiments the wetting composition further comprises water.

According to still further features in the described preferred embodiments one or more of the opaque liquid ink composition, the colored liquid ink composition and the wetting composition comprises a property-adjusting agent and one or more of the opaque liquid ink composition, the colored liquid ink composition and the wetting composition which does not comprise the property-adjusting agent comprises a property-sensitive agent, whereas the property-adjusting agent effects a chemical and/or physical change in the property-sensitive agent upon contacting the composition which comprises the property-sensitive agent and the composition which comprises the property-sensitive agent, and thereby effects a chemical and/or physical change in the wetting composition, the opaque liquid ink composition and/or the colored liquid ink composition which comprises the property-sensitive agent.

According to still further features in the described preferred embodiments one or more of the opaque liquid ink composition and the colored liquid ink composition comprises the property-sensitive agent and the wetting composition comprises the property-adjusting agent.

According to still further features in the described preferred embodiments the wetting composition is characterized by a surface tension lower than a surface tension of each of the opaque and colored liquid ink composition. Preferably, the surface tension of the wetting composition is lower than the surface tension of each of the opaque and colored liquid ink composition by at least 2 dynes per centimeter.

According to yet another aspect of the present invention there is provided a dark substrate having an image printed on a surface thereof, prepared by one of the processes described herein.

According to further features in preferred embodiments the image is characterized by wide and continuators L*a*b* color space, high optical density, high color definition, high resolution, no color bleeding, high durability, chemical-fastness and/or wash-fastness.

The present invention successfully addresses the shortcomings of the presently known configurations by providing an improved and efficient process for printing high-resolution, high-definition photorealistic color images on dark surfaces, which is far superior to the presently known methodologies.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

As used herein, the term “comprising” means that other steps and ingredients that do not affect the final result can be added. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

The term “method” or “process” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the singular form “a,” “an,” and “the” include plural references unless the context clearly dictates otherwise. For example, the term “a compound” or “at least one compound” may include a plurality of compounds, including mixtures thereof.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 presents a color photograph showing the rear side of a white cotton piece onto which a colored image was directly printed (without applying a wetting composition), demonstrating the great extent of the ink penetration through the cotton fabric;

FIG. 2 presents a color photograph showing the rear side of a white cotton piece onto which a colored image was printed by contacting the cotton piece with a wetting composition that comprises a property-adjusting agent, according to preferred embodiments of the present invention and thereafter printing the color image using a colored ink composition that comprises a property-sensitive agent, according to preferred embodiments of the present invention, demonstrating the limited penetration of the inks through the cotton fabric that is advantageously effected by the use of the wetting composition;

FIG. 3 presents a color photograph showing the front side of a black cotton piece onto which a layer of an opaque white liquid ink composition was directly printed (without applying a wetting composition), followed by printing a color image on top of the layer of the opaque white liquid ink composition, demonstrating the impairing effect of the great extent of the opaque white liquid ink penetration through the cotton fabric, expressed by the dullness of the colors in the image;

FIG. 4 presents a color photograph showing the front side of a black cotton piece onto which a color image was printed by contacting the cotton piece with an exemplary wetting composition that comprises a property-adjusting agent, according to preferred embodiments of the present invention, and thereafter printing a layer of an exemplary opaque white liquid ink composition, followed by printing the color image using an exemplary colored ink composition that comprises a property-sensitive agent, according to preferred embodiments of the present invention, demonstrating the beneficial effect of applying a wetting composition and effecting a chemical change in the colored ink composition on the colors vividness of the final printed image;

FIGS. 5a-b present comparative color photographs of three similar black cotton pieces: a black cotton piece onto which a colored image was printed by contacting the cotton piece with an exemplary wetting composition that comprises a property-adjusting agent, according to preferred embodiments of the present invention and thereafter printing the color image by applying two layers of an exemplary colored ink composition that comprises a property-sensitive agent, according to preferred embodiments of the present invention (FIG. 5a); a black cotton piece onto which a colored image was directly printed in two layers of the exemplary colored ink composition but without applying a wetting composition (FIG. 5b); and the color image on a black cotton piece presented in FIG. 4 (FIG. 5c), demonstrating the advantageous effect of the wetting composition on the visibility of a colored image as compared to the image printed on a dry substrate, and the greater effect of the combination of a wetting composition and an opaque white masking layer.

### DESCRIPTION OF THE PREFERRED EMBODIMENTS

The present invention is of novel processes for printing an image on a dark surface, which are particularly beneficial for printing multicolor images on dark and absorptive surfaces such as, but not limited to, dark textile fabrics and garments.

The principles and operation of the process according to the present invention may be better understood with reference to the accompanying descriptions and examples.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

As is described in detail hereinabove, meeting the demands of the modem textile and designer fashion industries requires processes and tools which can produce high-resolution, high-definition multicolor and photorealistic images on textile fabrics and garments of any colors and shades. The presently known and used textile printing technologies are all accompanied by one or more limitations which render them disadvantageous, ranging from image quality, image sustainability and hand-feel, to cost and time consumption in industrial scale.

In general, a conventional method of inkjet printing on any surface typically involves the binding of colorants in a form of a particular mix of substantially transparent liquid ink compositions, each having a different colorant, to the printed surface. The liquid ink compositions are required to be transparent since only a few (typically 3-5) basic colors are used and the full spectrum of colors and shades is achieved when these basic colors are mixed in various combinations in situ on the substrate. However, direct printing of multicolor images using transparent inks on any surface requires the surface, which is the background of the image, to be white or at least lightly-colored, since its inherent color participates in the formation of the final perceived color, together with the colorant in the inks applied thereon. Darkly colored surfaces tend to render the primary-colored ink drops indistinguishable or substantially color-skewed since the final perceived color stemming from any combination of the primary colors is a subtraction of that particular combination from the color white, or at least from a bright light color. It is therefore a physical requirement that the background of an image generated directly onto a surface be a bright light color.

As further discussed hereinabove, ink-jet printing of high-quality and high-resolution is based on placing very small dots of several basic colors near or virtually on top of each other so as to create a full spectrum of colors from the mixing of these basic colors. Each location of the image may be a unique mix of basic colors constituting a unique color. Thus, the transparency of the ink is crucial for creating the full spectrum as incident and substantially “white light” is filtered through the basic colors mix and reflected as a colored light back to the observer. The reflection of the light depends on the absorption of the background surface, hence on its color, and therefore non-white surfaces do not reflect all colors and as a result the ink or ink mixes forming the printed image are not perceived in their intended colors.

Thus, the key limitation in the process of applying substantially transparent liquid ink compositions on any non-white surface, and especially on darkly colored surfaces, stems from the inability of the non-white surface to reflect white light from the surface back through the applied transparent ink and to the eye of the observer, which renders the image dull, dark and color-skewed. Therefore presently known printing technologies are limited when applied on darkly colored or otherwise non-white surfaces.

The term “colored” as used herein refers to any non-white materials and substrates. White is defined herein as a color having an L* value of 100 and an a* and b* values of 0 on an L*a*b* color-model space, as this concept is known in the art and presented hereinbelow. Preferably a colored substrate is a darkly colored substrate, having an L* value of less than 50 and any a* and b* values on an L*a*b* color-model space.

Furthermore, in the case of absorptive surfaces, such as for example, textile surfaces, the liquid ink is required to bind to a fibrous, thus absorptive material. One of the key limitations in the process of applying a liquid and transparent ink on absorptive surfaces, such as those made of fibrous materials or other porous materials, stems from the interaction of the liquid ink with the surface once the ink is applied, and before the ink is fully cured and fastened to the fabric. As is well known to a skilled artisan, when ink droplets are absorbed into an absorptive material upon contacting the surface, the color dots begin to feather (bleed), spread out in an irregular fashion, and therefore cover a larger area than the intended area, thus producing a fuzzy image with dull colors and low definition.

Hence, while the quality of the printed image depends on the degree of absorption of the ink in the material of the subject surface, it is well recognized that in order to achieve a high-resolution and high-definition multicolor image on absorptive surfaces (obtained, for example, by spraying the inks onto the fabric's surface), it is highly desirable that an applied ink droplet would stay as a tight, symmetrical dot once being in contact with the surface, and until it is fully cured.

The presently known printing technologies are therefore limited when applied to absorptive surfaces such as textiles and others, and further when applied to surfaces that are characterized by high surface tension and/or glossy finish. In the latter type of surfaces, the ink droplets tends to expand and over-spread due to physical interactions adverse to the printing process, thus leading to reduced resolution of the printed image.

In a search for a comprehensive and efficient solution for the limitations associated with printing on dark surface, such as a dark textile fabrics, the present inventors have envisioned that the quality of a printed image could be enhanced by applying a lightly colored layer at specific location on the surface where a colored ink is designed to be printed. It was envisioned that using such a methodology, the transparent color inks applied on the lightly color background would be perceived by a viewer substantially in their intended color.

The present inventors have further envisioned that high-resolution, vividly colored, sturdy and pleasant-to-touch images could be obtained further temporarily modifying the physical, chemical and/or mechanical characteristics of the surface prior to the application of the lightly color layer and/or the colored ink.

The present inventors have further envisioned that since the printing process is evidently split to applying two or more compositions in more than one pass over the substrate, at least two of the compositions can contain substances that can react with one another upon contacting, so as to effect a beneficial quality to the finished image, such as tighter binding of the colorant to the substrate.

While reducing the present invention to practice, the present inventors have indeed uncovered that printing a color image on a darkly-colored substrate can be beneficially effected by first printing on the substrate a layer of an opaque, lightly-colored ink composition and thereafter printing the color image onto the lightly-colored later. The present inventors have surprisingly found that such a printing process is beneficially effected while printing the color image on the lightly-colored layer without curing the lightly-colored layer and further found that such a process can be advantageously performed using aqueous-based ink compositions.

Further while reducing the present invention to practice, the present inventors have uncovered that by applying to the surface a wetting composition, that is capable of interacting with engagement sites on the surface, prior to, concomitant with or subsequent to applying the lightly-colored and/or the colored ink compositions, resulted in high-quality images.

While further reducing the present invention to practice, the inventors took advantage of the fact that the above-described processes are effected by more than one pass of the printing machine over the surface, and added to one of the applied compositions an agent which is sensitive to a change in its chemical environment, and further added to another applied composition another agent which can effect this change by adjusting the chemical environment. The present inventors have surprisingly found that while using such compositions, the sensitive agent undergoes a change when it comes in contact with the adjusting agent, during the printing process and that this change resulted in an image with even more improved quality.

Hence, according to one aspect of the present invention, there is provided a process of printing a color image on a dark surface. The process, according to this aspect of the present invention, is effected by digitally printing, by means of an inkjet printing head, a layer of a substantially opaque liquid ink composition directly onto the dark surface; and digitally printing a colored liquid ink composition on the layer of the opaque liquid ink composition, to thereby form the color image. According to the present invention, the opaque liquid ink composition is capable of modifying a light interaction of the image so as to allow the transparent colors to be perceived by a viewer in their intended color.

The term “surface”, as used herein, refers to the exterior or upper boundary, the external part or layer or the outward appearance of a subject. This term is also used to describe any area of a surface, including specific parts of the surface.

The phrase “dark surface”, which is also referred to herein interchangeably as a “darkly-colored surface”, as used herein, describes a surface having any color which is not white (non-white), such as for example, a yellow surface, a gray surface, a red surface, a black surface and the likes. Preferably, the darkness of the surface has a color which is attributed an L* (lightness) value of 50 or less and any a* and b* values on the L*a*b* scale, as discussed hereinabove and further detailed hereinbelow.

As used herein, the term “L*a*b*” or “Lab*” refers to the CIE L*a*b* (International Commission on Illumination or Commission Internationale d'Eclairage, CIE) color model. Used interchangeably herein and throughout, CIE L*a*b*, L*a*b* or Lab is the most complete color model used conventionally to describe all the colors and shades which are typically visible to a normal human eye. The three parameters in the model define a particular color, whereas the lightness of the color is represented by the parameter L*, wherein L*=0 corresponds to black and L*=100 corresponds to white. The value between true magenta and true green is represented by the parameter a*, wherein a negative value indicates green and a positive value indicates magenta. The value between true yellow and true blue is represented by the parameter b*, wherein a negative value indicates blue and a positive value indicates yellow.

The dark surface can be, for example, a textile piece, a wood, a mineral, a metal and a plastic, and is preferably a textile piece.

The surface described above may form a part of a subject that is made of the same material or, alternatively, of a subject that includes one or more additional layers such as, for example, a paper layer, a foam layer, a textile fabric layer, a natural or synthetic rubber layer, a ceramic or glass layer, a resin layer and the likes, and any combination thereof.

Textile fabrics that are suitable for use in the context of this and other aspects of the present invention include, for example, woven fabrics, knitted fabrics, and non-woven fabrics such as felt fabrics.

The textile fabrics, according to the present embodiments, may include fibers from any animal, plant and/or synthetic source such as, for example, wool, silk, cotton, linen, hemp, ramie, jute, acetate, acrylic fabric, latex, nylon, polyester, rayon, viscose, spandex, metallic composite, carbon or carbonized composite, and any combination thereof.

The printing process of the present invention is highly suitable for garments made of one or more textile fabrics, and therefore according to a preferred embodiment of the present invention, the dark textile piece is a garment. An exemplary preferred garment is a cotton T-shirt.

According to preferred embodiments of the present invention, digitally printing the opaque ink layer is performed such that this layer substantially covers, without exceeding the designed area of said colored image. Thus, the opaque layer serves as a mask, covering every point and area which the image will eventually be printed on.

Further according to preferred embodiments of the present invention, this digital printing is performed such that the layer of the opaque ink, and subsequently the printed color image, are substantially coextensive.

As discussed hereinabove, a light interaction with an object includes absorption, reflection and transmission of almost none, some or almost all the wavelengths of light present in the light source. The first, opaque liquid ink composition is therefore selected such that it is capable of modifying a light interaction of the resulting image by being brightly-colored and preferably white, and more specifically, provides a brightly-colored background to the transparent ink composition constituting the colored ink composition to thereby modify the reflection and transmission of light from and through the image. U.S. patent application Ser. No. 10/461,414, which is incorporated by reference as if fully set forth herein, teaches some features of the white-opaque layer.

As used herein, the phrase “lightly-colored”, which is also referred to herein interchangeably as “brightly-colored” with respect to a composition or a background, describes a composition or a surface which is characterized by an L* value of more than 50 and any a* and b* values on an L*a*b* color-model space. Preferably a lightly-colored background or composition is characterized by an L* value of more than 85, and more preferably a lightly-colored background or composition is characterized by an L* value of more than 95.

The colored liquid ink composition can be a standard colored inkjet composition or a modified standard inkjet composition, and can be any transparent liquid ink composition, any semi-transparent liquid ink composition or any opaque liquid ink composition. Preferably the colored liquid ink composition comprises one or more of a transparent cyan liquid ink composition, a transparent magenta liquid ink composition, a transparent yellow liquid ink composition, a semitransparent and opaque black liquid ink composition, a semitransparent and opaque white liquid ink composition. More preferably, the colored ink composition comprises a mixture of all of the above.

In addition to modifying the light interaction of the printed image, the opaque liquid ink composition can alternatively be printed concomitant with and/or subsequent to digitally printing the colored liquid ink composition, namely be applied again to select regions of the image in another pass of the opaque liquid ink composition printing heads. Such an application of an additional lightly colored ink composition at selected regions and/or points of the image provides for enhancement of the lightly-colored hues and pure white regions in the image, and thus also provides for enhanced resolution and vividness of the printed image.

The process presented herein is preferably executed without curing or otherwise drying the opaque liquid ink composition prior to digitally printing the colored liquid ink composition thereon, namely the colored ink compositions are printed on the wet layer of the opaque liquid ink composition.

Each of the opaque and colored liquid ink compositions used in the process presented herein independently comprises a colorant and a carrier (bulk diluting fluid).

The printing process according to the present invention can be applied using a variety of liquid ink compositions typically used in printing techniques known in the art and therefore can be applied using aqueous-based ink compositions and non-aqueous solvent-based ink compositions.

The carrier can be, for example an aqueous carrier, comprising mainly water, or an organic carrier, comprising mainly an organic solvent.

Aqueous-based ink compositions typically contain deionized distilled water as a main carrier or solvent, and other carriers and coating chemicals such as, for s example, Cymel 323 (Cytec Industries).

Non-aqueous solvent-based liquid ink compositions typically contain an organic component as a main carrier or solvent. Non-limiting examples of non-aqueous solvent-based liquid ink compositions include as a carrier, or solvent, ethylene glycol butyl ether acetate (EGBEA), cyclohexanone, dipropylene glycol methyl ether (DPM), and/or diethylene glycol.

In general, non-aqueous solvent-based liquid ink compositions offer some advantages such as enhanced solubilizing effect of more types of colorants and other beneficial additives, higher evaporation rate (high volatility), and a typical, medium-range surface tension and are generally more compatible with mechanical parts of the printing machine. However, these solvents are costly and harmful for the user and the environment as waste.

On the other hand, water, which serves as the main carrier in aqueous-based compositions is a safe and readily available carrier which can offer the use of many safe and environmentally friendly colorants and additives, and can be more easily manipulated than an organic solvent with respect to its chemical properties such as ionic strength, pH, surface tension and other properties which can be optimized for inkjet applications.

As is demonstrated in the Examples section that follows, the present inventors have now surprisingly found that the methodologies described herein can be efficiently practiced using opaque and/or colored ink compositions which comprise an aqueous carrier (aqueous-based ink compositions).

Thus, according to preferred embodiments of the present invention, each of the opaque and colored ink compositions utilized in the process described comprises an aqueous carrier, whereby, the carrier is preferably water. Such ink compositions are also referred to herein, interchangeably, as “aqueous-based ink compositions”.

In addition to a carrier and a colorant, each of the opaque liquid ink composition and the colored liquid ink composition, independently, may further contain other components and additives which are selected so as to better the light interaction of the image after the printing process is completed making it brighter, fluorescent or glimmer, and the binding of the colorant during and after the printing process thereby prolonging the life of the image on the finished garment. Such additives (or components) may include lustrous and reflective particles, gloss-enhancing additives, wear-resistive agents, hand-feel improving agents and the likes. Representative examples include, but are not limited to, adhesion promoting agents, viscosity modifying agents, dispersing agents, thickening agents, surface active agents, surfactants, polyols, surface tension modifying agents and softeners.

The concentration of such additives in the liquid ink composition, according to this embodiment of the present invention, preferably ranges from about 0.01 weight percentage to about 75 weight percentage of the total weight of the liquid ink composition, more preferably from about 0.1 weight percentage to about 50 weight percentages of the total weight of the ink composition and more preferably from about 0.1 weight percentage to about 10 weight percentages of the total weight of the ink composition.

The additives described above can therefore be added, according to the present invention, to either one or both of the opaque or colored liquid ink compositions. Furthermore, these additives can be applied on the area on the image subsequently to the application of the liquid ink compositions either before or after the curing step. Applying, for example, an adhesion promoting agent on the printed image before the curing can be performed in order to enhance the wash-fastness of the colorants and provide mechanical and chemical protection to the printed image.

Exemplary formulations of preferred opaque and colored liquid ink compositions is based on the following percentage of content ranges:
Water 0-95%;
Glycols 0-95%;
Pigment/colorant 0-10%;
Resin binder or a polymeric dispersion 0-20%;
Resin/binder 0-50%;
Dispersing agent 0-15%;
Rheology modifier 0-10%;
Organic solvent 0-5%;
Additives (anti-foaming agents, leveling agents, surface active agents etc.) 0-2%; and
Adhesion promoting agent 0.01-20%

The opaque liquid ink composition can contain very low amounts of a colorant, and in some embodiments can contain no colorant at all, whereupon these cases the resin and other additives in the composition provide an opaque layer which can serve to reflect light. The opaque impression on the substrate is obtained like in many other polymeric materials, which are essentially colorless but when solidified in an amorphous state become opaque and substantially while.

Hence, according to preferred embodiments of the present invention, a concentration of the colorant in the lightly-colored opaque ink composition may range between 0 weight percentages to 10 weight percentages of the total weight of the composition. Alternatively, the concentration of the colorant in the lightly-colored opaque ink composition range from 10 weight percentages to 25 weight percentages of the total weight of the composition.

The requirement from the various liquid ink compositions to be fluid and cause ultimately no clogging in the fine fluid passages in the printing machine, and at the same time have the capacity to solidify and bind irreversibly to the material of the surface, put limits on compositions that can be used in inkjet machines. As discussed hereinabove, the balance between these requirements was considered by the present inventors whom hypothesized that the undesired compromise between fluidity and final durability requirements can be waived by using two fluid and cross-reactive agents which solidify or otherwise go through a chemical or physical change only upon contact therebetween. This feature can be effected according to the present invention since the image can be formed by more than one printing pass over the surface, and since each printed layer can be applied by a separate mechanical element, such as a printing head or a spraying nozzle, a chemical/physical property-sensitive agent can be added to the one of the liquid ink compositions applied in one pass, and a chemical/physical property-adjusting agent, can be added to the one of the other liquid ink composition applied in the other pass, thereby contacting these two agents when applied these two liquid ink compositions onto the surface. The event of the contacting initiates a chemical reaction upon which the colorant of either ink compositions settles and is better affixed on the surface of the substrate.

Hence, according to the process presented herein, at least one of the opaque liquid ink composition or the colored liquid ink composition includes a property-adjusting agent and at least one of the opaque liquid ink composition and the colored liquid ink composition which does not include the property-adjusting agent, includes a property-sensitive agent. The property-adjusting agent is selected such that it effects a change in said property-sensitive agent upon a contact therebetween, and thereby effects a chemical/physical change in either the opaque liquid ink composition or the colored liquid ink composition which includes the property-sensitive agent.

Preferably, the opaque liquid ink composition includes the property-adjusting agent and the colored liquid ink composition includes the property-sensitive agent. Thus, upon contacting the opaque ink composition during the printing process, the colored ink compositions undergoes a chemical change that prevents the penetration of the opaque ink into an absorptive substrate and enhances the adhesion of the colorant to the substrate, all of which enhances properties such as durability, wear-resistance, flexibility and vividness of the printed image.

In general, the objective of using a property sensitive and adjusting agents is to provide the means to generate a chemical reaction between two agents which are reactive therebetween such that the reaction will occur only on the surface of the substrate and not beforehand.

The term “property” as used herein refers to a chemical and/or physical property of the liquid ink composition, namely, a characteristic of the composition that is reflected by the chemical composition and/or a physical parameter of the composition. Representative examples include, without limitation, acidity (pH), ionic strength, solubility, hydrophobicity, electric charge and the likes.

The term “pH” refers to the quantitative measure of the acidity or alkalinity (basicity) of liquid solutions, and translates the values of the concentration of the hydrogen ion which ordinarily ranges between about 1 and 10E-14 gram-equivalents per liter into the exponent negative values which range between 0 and 14.

The phrase “ionic strength” as used herein refer to the charge-weighted concentration of ions in solutions.

The term “hydrophobicity” as used herein refers to a quality of a non-polar molecule or group that has little affinity to water or other polar solvents. Hydrophobic groups on molecules in a polar solution tend to turn in on themselves or clump together with other hydrophobic groups.

The term “solubility” as used herein refers to the amount of a solute that will dissolve in a specific solvent under given conditions. The reduction of solubility may be effected by a change in another chemical property such as pH, ionic strength and hydrophobicity.

The phrase “property-sensitive agent” refers to a component of the liquid ink composition which is sensitive to a change in a particular chemical and/or physical property of the liquid ink composition and as a result of such a change undergoes a chemical and/or physical change which effects the entire liquid ink composition.

The chemical or physical change that takes effect upon contacting these agents is preferably designed so as to afford better binding between the colorants and the substrate, and hence a preferred chemical and/or physical change can be, for example, solidification, adhesion, thickening, polymerization, sedimentation and cross-linking.

The action of thickening, sedimentation and subsequent solidification of one or more components in the liquid ink composition promotes adhesion of the colorant to the substrate by, for example, entanglement of these components with elements in the substrate upon polymerization and/or cross-linking thereof which is effected upon the abovementioned chemical or physical property change caused by the property-adjusting agent. For example, a property-sensitive cross-linking agent such as glutaraldehyde can become chemically reactive upon a change in the pH and interact with an amine-rich resin in the composition and form a semi-solid substance which adheres to the substrate as a mesh and entrap particles of the colorant in the mesh thereby promoting the adhesion thereof to the material of the substrate.

The phrase “property-adjusting agent” as used herein refers to an agent that forms a part of one liquid ink composition and can effect the level of one or more chemical or physical property of another liquid ink composition when coming in contact therewith, such as a pH level, the ionic strength, the hydrophobicity or the electric charge of the other composition. By effecting a change in one or more such properties, the property-adjusting agent is causing the property-sensitive agent to undergo a chemical and/or physical change, as discussed hereinabove.

The abovementioned chemical properties can be readily adjusted by adding a chemical substance (the property-adjusting agent) which lowers or elevates the level of these properties. For example, adding an acid (H+ ions) will elevate the acidity while adding a base will lower the acidity level. Similarly adding a salt will elevate the ionic strength, adding a precipitating agent will lower the solubility, adding a hydrophilic agent will lower the hydrophobicity, adding a charged species will elevate the electric charge, and so on, each property can be lowered or elevated by use of a suitable adjusting agent.

Exemplary property-adjusting agents present in one liquid ink composition, according to preferred embodiments, include acids and/or bases that adjust the pH property; salts that adjust the ionic strength and electrical charge; or oxidizing agents, reducing agents, radical-producing agents and cross-linking agents which change the chemical reactivity of certain chemical groups present in one or more components of the other liquid ink composition and thereby effect the solubility thereof by promoting cross-linking and/or polymerization of these components.

The concentration of the property-sensitive agent depends on its type and role in the liquid ink composition, namely if it is a main resin binder it will constitute up to 50% of the total weight of the composition and if it is a minor additive such as a dispersant, it will constitute up to 10% of the composition. Typically, the concentration of the property-sensitive agent ranges from about 0.5 weight percentages to about 50%, and more preferably 30% of the total weight of the composition comprising same.

The concentration of the property-adjusting agent should correspond adequately to the type and amount of the property-sensitive agent, and can range from about 0.5% to about 20% of the total weight of the composition.

The following describes a few representative, non-limiting examples, which present how the objective of using the property sensitive and adjusting agents is met:

An acid-base interaction can cause a resin that is soluble in a basic or neutral composition to precipitate once it comes in contact with an acid, whereupon such solidification leads to a sharp increase in the viscosity of the composition.

An acid-base interaction can cause an emulsion of a colorant and other components that can keep its low viscosity under basic conditions, to turn into a gel having a very high viscosity once it comes in contact with an acid. For example, adding polyvinyl alcohol with a low molecular weight to one of the aqueous-based ink composition and adding borax (sodium tetra borate) to the other composition will cause the formation of a gel upon contacting these two compositions. A similar effect will be achieved when using calcium acetate and isopropanol.

A resin being soluble in an aqueous solution will precipitate once it comes in contact with calcium and/or aluminum ions, whereupon it will become a solid and will effect a sharp increase in the viscosity of the combined composition.

A salt (ionic) interaction between anions and cations such that cause an emulsion to break and to its components to precipitate. Preferred salts for effecting an increase on the ionic strength include calcium salts such as calcium chloride and calcium acetate, and aluminum salts such as aluminum chloride and aluminum sulfate, and any combination thereof.

A hydrophilic-hydrophobic interaction between various solvents and polymeric latex resin that causes the resin to swell and precipitate and effect an overall rise in the viscosity of the combined composition.

A preferred chemical property, according to the present invention, is acidity, the preferred chemical adjusting agent is an acid, and preferably the acid is an organic acid. Preferably, the organic acid is a carboxylic acid such as, for example, a carbonic acid, a formic acid, an acetic acid, a propionic acid, a butanoic acid, an α-hydroxy acid such as glycolic acid and lactic acid, a halogenated derivative thereof and any combination thereof, and most preferably the acid is acetic acid.

In order to improve the stability of colorants and pigments on the surface once applied (and optionally cured or otherwise dried), it is known in the art that adhesion promoting agents can be used to affix the pigments to the surface. According to the present invention one or both of the opaque and/or colored liquid ink compositions include, for example, an adhesion promoting agent which is soluble when present in the ink composition and may also acts as a dispersing agent for the various colorants and pigments which are included in these ink compositions, but precipitates and/or solidifies when, for example, the pH of the media it is dissolved in drops below a certain pH level, therefore it is a pH-sensitive dispersion and adhesion promoting agent.

According to the present embodiments, one of the liquid ink compositions includes a pH-adjusting agent, namely an acid, which upon contacting the other ink compositions, lowers the pH thereof and thereby lowers the pH of the media of the pH-sensitive dispersion and adhesion promoting agent, causing it to precipitate and solidify, hence affixing the colorants and pigments of the ink compositions and affords a durable printed image which is wash-fast, chemically robust and resistant to physical wear.

Hence, the chemical/physical property-sensitive agent, which undergoes a chemical reaction or physical change as a result of contacting the chemical/physical property-adjusting agent, is preferably an adhesion promoting agent, a dispersing agent, a viscosity modifying agent, a thickener agent, a surface tension modifying agent, a surface active agent, a surfactant and a softener, which form a part of one of the liquid ink compositions. Preferably the chemical/physical property-sensitive agent is an adhesion promoting agent.

Exemplary adhesion promoting agents include, without limitation, an acrylic polymer, a polyurethane emulsion, a polyurethane polymer, a polyether polymer, a polyester polymer, a polyacrylate polymer, a polyvinyl chloride polymer, a polyvinyl acetate polymer, a polyvinyl butyral polymer, an aminosilicon polymer and any combination thereof.

The various ink compositions, namely the opaque ink compositions and/or the colored ink compositions are preferably aqueous based ink compositions which include a polymer which serves as a dispersion agent and a pH-sensitive adhesion promoting agent which precipitates when one ink composition come in contact with the other ink composition when these compositions are applied one after the other on the surface.

Exemplary formulations of the ink composition is based on the following percentage of content ranges:
Water 0-95%
Glycols 0-95%
Pigment/colorant 0-35%;
Resin binder or a polymeric dispersion 0-20%;
Resin/binder 0-50%
Dispersing agent 0-20%
Rheology modifier 0-10%
Organic solvent 0-5%
Additives (anti-foaming agents, leveling agents, surface active agents etc.) 0-2%
Property sensitive agent 0-50%
or a property adjusting agent 0-35%

The property sensitive agent can be present as a main resin/binder (content of up to 50%), or a secondary resin/binder (content of up to 20%), or as a dispersant (content ranging from 0 to 20% or up to 60% of the pigment/colorant), or as a resin binder or a polymeric dispersion (content ranging from 0 to 20%).

Preferably the ink composition is alkaline (basic) so as to maintain the sensitive adhesion promoting agent in its soluble form, and therefore the pH setting agent is a base.

Further according to preferred embodiments of the present invention, once the colored ink composition is printed and the colored image is formed, the process further comprises curing the formed image. Thus, while the printing process is preferably effected without curing intermediate layers nor the last layer applied onto the substrate, the printing process may further include, subsequent to the formation of the image, curing the image. The curing can be effected by heat and/or dry air emanating from a heat source such as, for example, an infrared conveyor or a filament coil, or a dry air source such as, for example, a hot air blower.

The term “curing” as used herein describes an active process that also results in a substantial removal by evaporation of all carriers of all liquid compositions used throughout the printing process. Such evaporation, when occur spontaneously upon being subjected to environmental conditions for a short time period (e.g., a few minutes or less) is not referred to herein as curing.

WO 2005/115089, by the present inventors/assignee which is incorporated herein by reference in its entirety, teaches a composition and method for printing a color image on an absorptive surface, such as textile fabrics, while utilizing a wetting composition.

While further conceiving the present invention, it was hypothesized that use of a wetting composition, such as taught in WO 2005/115089, which provides a temporary modification of an absorptive surface, could improve the reception and interaction of the opaque liquid ink composition and the subsequent colored liquid ink composition with the substrate, and particularly if the substrate is absorptive.

As taught in WO 2005/115089, the temporary modification of the surface is achieved by contacting the surface with wetting composition that temporarily modifies the characteristics of the surface such that the engagement of a liquid ink composition with the binding sites of surface would be decreased. Such a wetting composition can be comprised of water or of a simple, available organic composition and thus it was envisioned that combining this methodology with the process presented herein would result, in addition to allowing printing a color image on a darkly colored surface, also the reduction of ink absorption, being it the opaque or the colored liquid ink composition, and improved quality of the image, in a more cost-effective process, and in a printed surface with no adverse characteristics such as color bleeding and unpleasant feel.

The wetting process provides an on-demand, fast and optimally minimized pre-treatment of the substrate such as a garment piece. Although pre-treated fabrics may be commercially obtained or otherwise prepared off-line at any time prior to the printing process, and at any location away from the printing machine, this extra garment-handling step is time and labor consuming and may result in unnecessary treatment of large parts of the garment where there is no need for such treatment, and unnecessary treatment of pieces which are not required do to rapid change of commercial demand.

This concept, in combination with the abovementioned concept of printing a colored image onto a dark surface, meets several main objectives, all of which are accomplished by this comprehensive printing process presented herein, thereby obtaining a high-resolution, high-definition, vividly-colored, mechanically stable and pleasantly sensed image on a textile surface of any color or shade, as follows:

(i) prevent bleeding of the liquid ink into the surface, causing feathering of the ink-droplets and a considerable waste of ink, by locally and temporarily modify the surface characteristics of the surface to thereby allow the formation of small and well-defined ink droplets on the surface of the substrate until these droplets are dried thus forming small and well defined ink dots on the surface.

(ii) provide a brightly-colored background to the transparent ink dots applied thereon so as to provide incident light a surface it can be reflected from the through the applied ink dots, thereby allowing even darkly colored surfaces to serve as a substrate for printing color images thereon.

(iii) provide a two-components chemical interaction to occur on the surface on the substrate when two liquid ink compositions, namely the opaque and the colored ink compositions, or the wetting composition, are put in contact during the printing process of the image, so as to affix the colorant (pigment) in the droplets of the ink compositions onto the surface of the substrate, thereby allowing the formation of a highly stable, wash-fast and yet pleasantly sensed printed image of the surface of the subject which is much more robust and resistant to physical wear and tear.

While reducing the present invention to practice, as is demonstrated in the Examples section that follows, the present inventors have found that utilizing such a methodology indeed results in a significantly improved quality of the printed image. More specifically, it was found that contacting a textile surface with a wetting compositions, prior to applying a liquid ink composition thereon, rendered the surface of the textile fabric temporarily less absorptive to the ink, such that the dots of the ink did not feather or bleed until the ink was fully applied. Further it was found that printing a mask of white opaque liquid ink composition on the exact area onto which the image is printed, subsequent to applying a wetting composition, and applying a colored liquid ink composition on top of the opaque liquid ink composition, as presented hereinabove, preferably without curing the wetting composition or the opaque white layer, affords a sharp, highly defined and vivid image on any colored surface, and particularly on darkly colored textile surfaces.

Thus, according to another aspect of the present invention, there is provided a process of printing a color image on a dark surface, which includes contacting at least a part of a the surface of the dark textile piece with a wetting composition so as to provide a wet part of said surface; digitally printing, by means of an inkjet printing head, a layer of a substantially opaque liquid ink composition directly onto the dark surface; and digitally printing a colored liquid ink composition on this layer of opaque liquid ink composition and/or the wetting composition, to thereby form the color image. According to this aspect, the wetting composition is capable of modifying the interactions of the opaque liquid ink composition with the surface and/or the colored liquid ink composition with the surface, and further the opaque liquid ink composition is capable of modifying a light interaction of the image, as presented hereinabove.

This process can be applied to any surface, and is particularly suitable for printing a colored image onto dark and absorptive surfaces, such as textile, wood or other fibrous materials. Preferably, the surface is a dark textile piece made of cotton.

As is discussed hereinabove, the wetting composition is selected capable of temporarily modifying an interaction between either of the opaque liquid ink composition and/or colored liquid ink compositions and the surface. Such a modification includes, for example, temporarily modifying a mechanical property of the surface by, for example, reducing the contact area between the ink composition and the surface by, e.g., filling the pores in the surface or flattening perturbing objects such as stray fibers; temporarily modifying a physical property of the surface by, for example, reducing the surface tension formed between the surface and the ink composition; and temporarily modifying a chemical property of the surface by, for example, engaging the binding sites of the surface by, e.g., interacting with functional groups on the surface, masking, neutralizing or inverting the charge of functional groups on the surface.

By applying a wetting composition onto an absorptive surface prior to applying any liquid ink composition, one can turn a highly absorptive material such as a so-called low quality inkjet printing paper into a high quality inkjet printing paper, and similarly turn highly absorptive fabrics from unacceptable media for inkjet printing into a suitable media.

As discussed hereinabove, this process of printing a color image is preferably conducted without curing or drying after any of the intermediate passes, namely without curing the wetting composition, and without curing the layer of opaque liquid ink composition prior to printing the color image thereon.

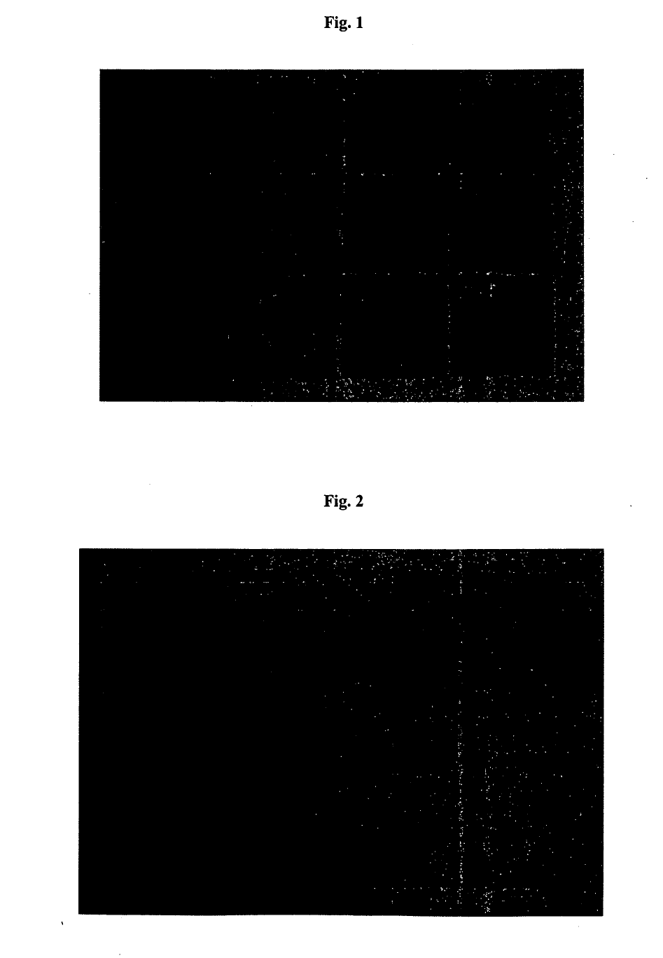

As further described hereinabove and demonstrated in the experiments presented in FIGS. 1 and 2, the main effect of the wetting process is the reduction and possibly the elimination of the penetration and absorption of a given liquid ink composition into a porous surface such as a textile piece, namely the interference of the interaction between the surface and the liquid ink composition. When this interference is achieved, liquid ink drops will tend to remain atop the surface of a porous material, resulting in high optical density which leads to higher color intensity. Furthermore, less ink penetrates the porous material, thus less staining occurs while less ink is consumed in order to achieve the required color qualities. This effect is highly desirable for the opaque liquid ink composition as this layer is preferably applied at a high density so as to achieve a uniform and fully covering mask for the color image.

Other benefits which stem form the use of the wetting process include the ability to use less expensive ink and less colorant, increasing the printing rate and especially the printing resolution, therefore achieve higher color qualities, decreasing final cure cycle and improving hand feel.

Contacting the surface with the wetting composition, according to the process of the present invention, may be performed by any method or technique for applying a liquid onto an object, including, but not limited to, spraying, ejecting, smearing, spreading, brushing, dipping, dripping, impregnating, pouring, condensing, scattering, dispersing, dissipating, dissolving, melting, or a combination of some of these wetting methods. Alternatively, contacting the surface with the wetting composition can be effected by converting a composition to a liquid form on an object, namely by condensation of a vaporized liquid onto the surface or melting a solidified liquid onto the surface. A suitable method is selected so as to comply with the physical properties of a specific wetting composition, and to comply with a given printing machine and technology.

According to a preferred embodiment of the present invention, contacting the surface with the wetting composition is effected by spraying, ejecting or dripping the wetting composition onto the desired part of the surface, by means of a liquid applicator. These methods are most suitable for a controlled and automatic in-line wetting procedure, and can therefore be easily implemented as a part of many mechanized printing techniques.

As used herein, the phrase “at least a part of the surface” describes one or more areas of the surface, and includes also the entire surface. Preferably the part of the surface that is contacted with the wetting composition includes the area onto which the ink is later on applied, namely, the total area covered by the printed image. The areas may be continuous or discontinuous.

In an attempt to avoid unnecessary and excessive use of the wetting composition, the preferred mode of applying the wetting composition resembles the mode of applying the opaque liquid ink composition, namely the wetting composition is applied only in those parts of the surface onto which the various liquid ink compositions are applied.

Contacting the surface with the wetting composition can be further controlled by pre-determining the area of the surface that is to be wetted by the wetting composition, so as to contact with the wetting composition only that specific, pre-determined area of the surface onto which the image is printed in the subsequent stage of the process. The pre-determination of the area to be wetted allows for optimization of the entire printing process which depends on accurate material quantification, namely the wetting and the ink compositions, and accurate timing of each printing steps, namely the wetting, the ink application and the curing steps. The pre-determination of the area of the surface can by readily established by a computerized algorithm. In other words, the surface is covered selectively by the wetting composition on pre-determined parts thereof according to the outline and shape of the image to be printed. This mode of application can be effected by using a designated and adapted print-head or nozzle that can be driven and operated digitally like a typical inkjet printing head. Hence, according to a preferred embodiment of the present invention, the part of the surface that is contacted with the wetting composition is pre-determined digitally.

The wetting composition is composed of a carrier and optionally one or more additional components which serve to heighten the effect of the wetting composition such as surface tension altering agents and the likes, and preferably the carried of the wetting composition is water.

Various characteristics pertaining to the content, preferred qualities and mode of application of the wetting composition are described in detailed in WO 2005/115089 which is incorporated by reference as if fully set forth herein.

According to preferred embodiments of the present invention, the wetting composition and the various liquid ink compositions, namely the opaque and the colored ink compositions are selected such that the surface tension of the wetting composition is lower that the surface tension of any of the liquid ink compositions, and particularly the opaque liquid ink composition which is applied densely on the wetting composition before the colored ink compositions. Preferably, the surface tension of the wetting composition is lower than the surface tension of the opaque and the colored liquid ink composition by at least 2 dynes per centimeter, more preferably by at least 3 dynes per centimeter, more preferably by at least 5 dynes per centimeter and even more preferably by at least 10 dynes per centimeter.

According to preferred embodiments of the present invention, the wetting composition includes one or more organic solvents. Preferred solvents include, without limitation, low alcohols such as ethyl alcohol, n-propyl alcohol, isopropyl alcohol and butyl alcohol, and glycol ethers such as dipropylene glycol ether, tripropylene glycol ether and methoxy propanol.

Alternatively the wetting composition consists substantially on an alcohol such as the alcohols presented hereinabove. Further alternatively, the wetting composition comprises a mixture of an alcohol and water.

Since, as is discussed hereinabove, the wetting composition is aimed at temporarily modifying the mechanical, physical and chemical properties of the surface during the application of the ink thereon, while not affecting other properties of the surface, it is highly desirable that at least a majority the wetting composition could be removed from the surface once the printing process is completed. One of the simplest routes of removing substances under these conditions is by evaporation. Therefore, preferred organic solvents are characterized as volatile.

The most preferred wetting compositions according to the present invention include water or isopropyl-alcohol and one or more additives as described hereinabove.

As discussed hereinabove, the wetting composition according to the present invention may optionally further include one or more agents which may additionally alter the interaction of the ink composition with the surface.

These agents include, for example, one or more adhesion promoting agents. As is well known in the art, adhesion promoting agents are typically comprised of one or more substantially saturated, predominantly or substantially hydrocarbon oligomers or polymers, containing reactive functional groups that are capable of reacting with a co-polymer or a cross-linking agent upon heat exertion, oxidation, drying and other chemical and physical conditions. By being cross-linked, the adhesion promoting agents typically form an adhesive film.

The addition of the adhesion promoting agent(s) to the wetting composition of the present invention beneficially affects the properties of the resulting image by stabilizing the colorants of the liquid ink compositions after the curing procedure, and thus improving the wash-fastness of the printed image. The addition of the adhesion promoting agents may optionally also improve the surface tension relations between the wetting composition and the various liquid ink compositions.

Similarly to the relationship between the opaque and colored liquid ink composition in the above-described aspect, wherein one ink composition contains a property sensitive agent as this concept is described hereinabove, and the other contains a property adjusting agent as this concept is also described hereinabove, so is the relationship between the wetting composition and each of the opaque and/or colored liquid ink compositions, namely the wetting composition may comprise either a property sensitive agent or a property adjusting agent which corresponds to a property sensitive or adjusting agent in one or both liquid ink compositions.

Furthermore, the property sensitive or adjusting agent in the wetting composition can correspond to a property sensitive or adjusting agent in the opaque liquid in composition, which is the composition which the layer follows the wetting composition, and the opaque liquid in composition may have yet another property sensitive or adjusting agent which corresponds to another property sensitive or adjusting agent in the colored liquid ink composition. According to these embodiments when each layer is added on top of the previous layer, a different chemical or physical change in effected and the resulting image is further reinforced.

Exemplary formulations of the wetting composition, according to preferred embodiments are based on the following percentage of content ranges:
Water as an aqueous-based wetting composition carrier 90-99%
A property-adjusting agent 0-10%
Other additives 0-5%
Surface active agent 0-0.5%

Most preferably the wetting composition comprises a property adjusting agent and at least one of the opaque and/or colored liquid ink compositions comprises a property sensitive agent. Preferably, the property adjusting agent is volatile.

For example, the wetting composition can comprise water and a relatively small amount of an organic acid, acting as a pH adjusting agent. In these cases, the water content of the wetting composition preferably ranges from 90% to 99.9% and the organic acid content in the wetting composition ranges from 10% to 0.1% respectively to the water content. More preferably the water content is 99.5% and the acid content is 0.5% and the organic acid is a volatile organic acid such as formic acid or acetic acid.

In order to demonstrate the effect of the combined methodologies of using a wetting composition and a property-sensitive and property-adjusting agents, a color image of a 4×3 matrix of squares was printed on a cotton piece and a photograph was taken from the front (top) and rear side of the fabric. In the image each column is of one basic CMYK color, namely cyan, magenta yellow and black, and in each row the same colors are printed at a different printing coverage whereas 100 (%)=727 dpi×727 dpi, 75 refers to 75% coverage and 50 refers to 50% coverage. For a comprehensive description of the experiment, see Example 11 in the Examples section that follows.

FIG. 1 presents the rear side of a white cotton piece onto which the image was printed using an exemplary colored ink composition according to the present embodiments, comprising a property sensitive agent, namely a resin binder that settles at low pH, but without the use of a wetting composition, and FIG. 2 presents the rear side of the same cotton piece into which the same image was printed using the same colored ink composition subsequent to contacting the surface of the substrate with an exemplary wetting composition according to present embodiments, containing a property-adjusting agent, namely acetic acid, as an organic acid for adjusting the pH. As can be seen in FIG. 1, the inks penetrated the cotton fabric and left a very clear impression of the inverse image, however, as can be seen in FIG. 2, when the wetting composition comprising a pH-adjusting agent was applied, the inks comprising a property-sensitive agent hardly penetrated the fabric and only a faint impression of the image is visible.

The printing processes presented herein can be carried out, for example, using the following procedures:

(i) a substrate is placed on the printing platform of the printing machine;

(ii) the part of the surface onto which the image in about to be printed is optionally sprayed with the wetting composition, optionally by a digitally controlled process;

(iii) the now wet part of the surface onto which the image in about to be printed is digitally printed with a white or otherwise a lightly-colored and opaque ink composition;

(iv) a mix of colored liquid ink compositions is digitally printed so as to form the color image on the opaque white mask layer while still wet from the wetting composition and the undried opaque white ink composition.

(v) the image is cured or let dry.

The order of the various steps may be altered and/or repeated such that, for example, a second pass of wetting composition can be applied onto the opaque liquid ink composition, and/or a second pass of the opaque liquid ink composition can be printed over the color image so as to brighten the white and/or brightly-colored parts of the image.

In order to demonstrate the effect of the combined methodologies of printing a color image on an absorptive and darkly-colored surface, which are effected by using a wetting composition, using an opaque layer of a lightly-colored ink and a property-sensitive and property-adjusting agents, the same image which was printed on a white cotton piece to demonstrate effect of the wetting composition and the property-setting and adjusting effect, as presented in FIGS. 1 and 2 hereinabove, was used to demonstrate this effect on a black cotton piece.

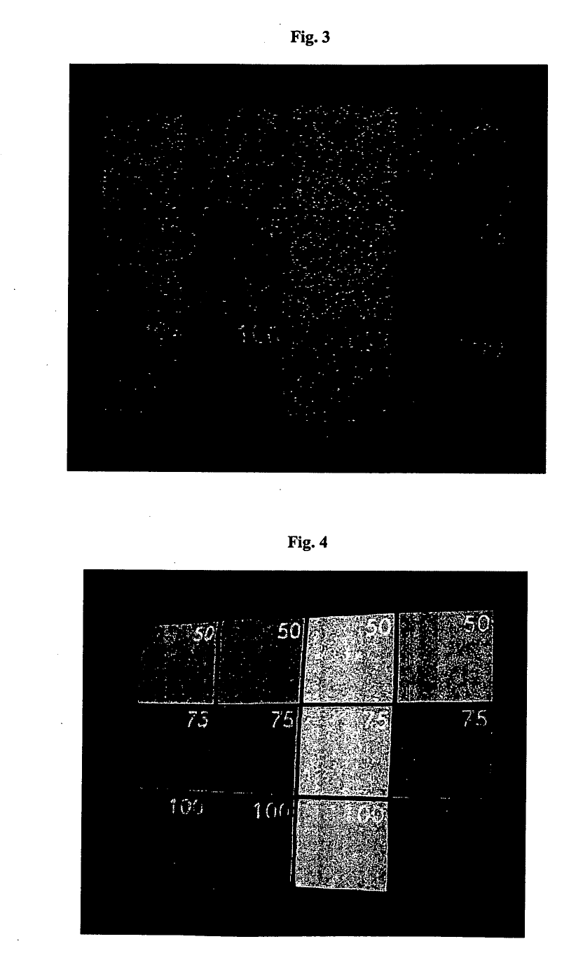

FIG. 3 presents the front side of a black cotton piece onto which an exemplary opaque white mask and a color image were printed without the use of a wetting composition prior to applying the opaque white liquid ink composition, wherein both liquid ink compositions comprised a property-sensitive agent. FIG. 4 presents the front side of the same cotton piece onto which the same white mask and the same image, were printed subsequent to applying the wetting composition which comprised a property-adjusting agent. As can be seen in FIG. 3, the colors appear dull and with little distinction between the various printing coverage (row-wise), however, as can be seen in FIG. 4, when the wetting composition was applied, the colors on the image appear vividly and the various coverage are clearly distinguishable. For a comprehensive description of the experiment, see Example 12 in the Examples section that follows.

The process can further be effected, as described herein, without applying the wetting composition, depending on the particular properties of the substrate such as the absorptiveness thereof. The printing processes described herein produce colored images on darkly colored surfaces, which are characterized by improved resolution, definition and brightness, as compared with the presently known printing technologies, and is further useful for printing multicolor images on absorptive and other surfaces.

The process described hereinabove can be performed on any desirable surface r, using an appropriate printing machine. Thus, the surface can be a flat surface and a non-flat surface such as a curved surface or any uneven surface.

While reducing the present invention to practice, the present inventors have analyzed the image digitally to deduce the exact characteristics of the surface prior to any treatment, after applying the brightly-colored and opaque liquid ink composition both in spatial position (coordinated) and intensity (density), and thereby formed a digital representation of the mask for the brightly-colored background layer, and subsequently translated this representation to printing commands executable on an inkjet printing machine. The present inventors have optionally contacted the surface with a wetting composition, digitally applied a white and opaque liquid ink composition onto a black textile surface so as to form a white-colored background layer according to the digital layout of the printing mask using an inkjet printing machine, and subsequently printed, without curing the white layer, a color image onto the brightly-colored background layer using the same inkjet printing machine and finally achieved a vivid multicolor image on a black textile surface.

As is demonstrated in the Examples section that follows, by contacting the surface, prior to the formation of the image, with a suitable wetting composition, the feathering and bleeding of the ink dots one into the other is substantially reduced, the ink droplets exhibit a tight and symmetrical droplet shape when applied onto the wetted surface, higher optical density of ink on the surface is achieved (allowing printing of higher-resolution images), and the ink does not infiltrate to the back side of the surface. The use of a volatile solvent in the wetting composition allows for complete or substantially complete removal thereof, as is shown by the absence of noticeable traces of the wetting composition after the image is cured.

It is expected that during the life of this patent many relevant liquid applicator devices and ink applicator devices and systems will be developed and the scope of the terms herein, particularly of the terms “spraying nozzles” and “inkjet nozzles”, is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions; illustrate the invention in a non limiting fashion.

### Material and Methods

General Printing Procedure:

In all the Examples below, a “Kornit 930” or a “Kornit 931” digital printing machine (manufactured by Kornit Digital Ltd., Israel) and equipped with a wetting system for applying the wetting composition, as described hereinabove, were used.

Printing was typically performed on the surface of a 100% cotton textile T-shirt. Similar tests were also performed on a surface of 50% cotton and 50% polyester, yielding the same results.

The T-shirts were ironed for 5 seconds at 160° C. using an automatic press. Thereafter the ironed T-shirts were mounted on the digital printing machine.

The merits of the resulting multicolor image was assessed both qualitative (visually inspected) and quantitative (numerically parameterized). An exemplary multicolor image was printed for a qualitative assessment of the printing process and the resulting image. For a quantitative assessment of the printing process and the resulting image, four color squares (4×4 cm), each having one pure CMYK color were printed on the T-shirts without applying a wetting composition and compared to color squares printed with the wetting composition. The color squares were printed at 100% and 50% surface coverage on white T-shirts and 100% surface coverage on a black T-shirts. All prints were cured in an IR curing unit prior to testing.

Specifically, unless otherwise stated, the experimental preparations for printing on 100% cotton white T-shirts purchased from Anvil Ltd. included:
Machine type: KORNIT 931 D;
Printing resolutions of 727×727 dots per inch;
Wetting composition spraying rate of 0.08-0.014 grams per square centimeter;
Curing cycle: 160 sec at 160 C using a press; and
   for printing on 100% cotton black T-shirts (Beefy-T) purchased from Hanes included:
Machine type: KORNIT 931 D;
Printing resolution for two layers of opaque white ink composition at 636×454 dots per inch and one layer of water based CMY ink compositions at 636×454 dots per inch;
Wetting composition spraying rate of 0.025-0.032 grams per square centimeter;
Curing cycle: 160 sec at 160 C using a press.

Measuring Equipment:

Colorimeter/densitometr Eye-One (I1) by Gretag Macbeth. Optical density measured using filter standard ANSI A (Internal auto calibration). Lab* (internal auto calibration) measured using observer angle 2 degrees and illumination set to D50.

Quantitative Assessment of Printing:

It is noted herein that there is a noticeable difference between the results as measured after conducting identical printing experiments using different textile pieces even when classified as similar, and even when coming from two different lots made by the same manufacturer. Namely, identical printing experiments using 100% cotton T-shirts of the same color including white, give varying results.

Nevertheless, the remarkable difference between prints with the use of a wetting composition and prints not using a wetting composition, always remain. In some textile types the amount of wetting composition and the optimal resolution at which the liquid ink composition can be applied may vary due to the fabric composition and nature, namely each textile type may require an adjustment for the optimal wetting amount and printing resolution. Using these optimized parameters will result in the most outstanding beneficial contribution of the wetting process.

An improved printing process on a textile piece achieves higher color intensity and brightness, namely high optical density, which can be translated into better coverage of a porous and non-uniform surface such as in the case of a textile piece.

In order to assess the quality of the resulting color prints using the process presented herein, several parameters were measured:

Lab* values which represent a three dimensional color space called calorimetric uniform color space as described in details hereinabove. In this color space model every set of three numbers (L, a* and b*) represents one specific color that the human eye can perceive. The combination of all possible numbers (colors) affords the sum total (also known as the gamut) of the visual color range. Lab* values are used in the printing industry to quantify colors for evaluation of color differences (see, ΔE below), color gamuts, color transformations and other color qualities. The units of Lab* are absolute numbers.

Density, or optical density (OD) is a logarithmic scale of relative light reflectance from a defined surface. Optical density is used in the printing industry to measure quantities of ink deposits of printed materials. Since OD is determined with respect to a reference color, the units of OD are absolute numbers.

ΔE (pronounced “delta E”) is a measure of color difference between two colored objects which is calculated from their calorimetric values such as Lab*. The smaller the ΔE value, the closer the two colors are to one another visually.

Standard reference of C, M, Y and K colors are used to determine the calorimetric definition of tested colors in terms of Lab* values. These serve as standard benchmark for measuring, for example, inkjet printing quality.

The numeric difference in the optical density and Lab* values between multicolor images printed with and without wetting in an otherwise similar process were compared, measuring the front and the back side of the subject T-shirt.

### Example 1

A non-aqueous solvent-based ink composition, having the four basic formulations of cyan, magenta, yellow and black colors (CMYK) was used.

A 100% cotton shirt was mounted onto the machine, as described above, and a multicolor image was directly printed on the fabric surface using an inkjet printing heads.

The printed image was then subjected to curing, by heating to 150-180° C. for 180 seconds using an infrared curing unit.

### Example 2

The same ink composition as in Example 1 was used for printing the same image, upon wetting the cotton shirt with an exemplary wetting composition according to the present invention.

Thus, a 100% cotton shirt was mounted onto the machine, as described above. 100% isopropanol was uniformly applied onto an area of the cotton fabric, using a spraying nozzle, at a density of 0.25 grams per cm² area of the cotton fabric.

Immediately thereafter, while the cotton fabric was still wet with the isopropanol, the image was printed on the wet area of the shirt surface using an inkjet printing head and the ink composition described above.

The printed image was then subjected to curing, by heating to 150-180° C. for 180 seconds using an infrared curing unit.

### Example 3

A non-aqueous solvent-based ink composition having the four basic formulations of cyan, magenta, yellow and black colors (CMYK) was used.

A 100% cotton shirt was mounted onto the machine, as described above, and a multicolor image of squares of each color formulation was directly printed on the fabric surface using an inkjet printing heads.

The printed image was then subjected to curing, by heating to 150-180° C. for 180 seconds using an infrared curing unit.

In a parallel test, the same process was repeated while uniformly applying 100% isopropanol onto an area of the cotton fabric prior to applying the ink formulations, as described hereinabove in Example 2.

The optical density of each of the colored squares, in each of the printed shirts (with and without pre-treatment with a wetting composition according to the present invention) was measured, using Shamrock Color Print 415. Table 1 below presents the optical densities values that were recorded and clearly show the higher values obtained following pre-treating the fabric with a wetting composition according to the present invention.

TABLE 1

| | Optical density without | Optical density with a |
|---|---|---|
| | a wetting composition | wetting composition |
| Color | (OD) | (OD) |
| Cyan | 1.25 | 1.40 |
| Magenta | 0.95 | 1.20 |
| Yellow | 0.75 | 0.90 |
| Black | 1.25 | 1.40 |

### Example 4

The following non-aqueous solvent-based ink composition was used:
Ethylene glycol butyl ether acetate (EGBEA) 80.0 grams
Cyclohexanone 4.0 grams
Dipropylene glycol methyl ether (DPM) 10.0 grams
Microlith Black preparation 6.0 grams

A spraying nozzle attached to the printing machine was used to uniformly apply the wetting composition onto the subject surface.

A 100% cotton fabric was mounted onto the machine, as described above. 100% butanol was uniformly applied onto an area of the cotton fabric, using the spraying nozzle, at a density of 0.40 grams per cm² area of the cotton fabric.

Immediately thereafter, while the cotton fabric was still wet with the butanol, an image was printed on the wet area of the fabric surface using an inkjet printing head and the ink composition described above.

The printed fabric was then subjected to curing, by heating to 150-180° C. for 180 seconds using an infrared curing unit.

Compared to a similar image printed on a similar fabric using the same print-head and ink composition, but without the pre-wetting step, the image resulting after applying the above wetting composition displayed no visible feathering signs. The optical density of the image was higher, and less ink was transferred to the back side of the fabric.

### Example 5

The following non-aqueous solvent-based ink composition was used:
Ethylene glycol butyl ether acetate (EGBEA) 80.0 grams
Cyclohexanone 4.0 grams
Dipropylene glycol methyl ether (DPM) 10.0 grams
Microlith Black preparation 6.0 grams

A spraying nozzle attached to the printing machine was used to uniformly apply the wetting composition onto the subject surface.

A 100% cotton fabric was mounted onto the machine described above. A mixture of 97% isopropanol and 3% SCX 8383 acrylic emulsion (Johnson Polymers) was uniformly applied onto an area of the cotton fabric, using the spraying nozzle, at a density of 0.40 grams per cm² area of the cotton fabric.

Immediately thereafter, while the cotton fabric was still wet with the wetting composition, an image was printed on the wet area of the fabric surface using an inkjet printing head and the ink composition described above.

The printed fabric was then subjected to curing, by heating to 150-170° C. for 60 seconds using an infrared curing unit.

Compared to a similar image printed on a similar fabric using the same print-head and ink composition, but without the pre-wetting step, the image resulting after applying the above wetting composition displayed no visible feathering signs. The optical density of the image was higher, and less ink was transferred to the back side of the fabric.

### Example 6

The following non-aqueous solvent-based ink composition was used:
Ethylene glycol butyl ether acetate (EGBEA) 80.0 grams
Cyclohexanone 4.0 grams
Dipropylene glycol methyl ether (DPM) 10.0 grams
Microlith Black preparation 6.0 grams

A pipette was used to uniformly apply the wetting composition onto the subject surface.

A 100% cotton fabric was mounted onto the machine described above. 100% petroleum ether (80-100) was uniformly applied onto an area of the cotton fabric, using the pipette, at a density of 0.40 grams per cm² area of the cotton fabric.

Immediately thereafter, while the cotton fabric was still wet with the wetting composition, an image was printed on the wet area of the fabric surface using an inkjet printing head and the ink composition described above.

The printed fabric was then subjected to curing, by heating to 150-170° C. for 150 seconds using an infrared curing unit.

Compared to a similar image printed on a similar fabric using the same print-head and ink composition, but without the pre-wetting step, the image resulting after applying the above wetting composition displayed no visible feathering signs. The optical density of the image was higher, and less ink was transferred to the back side of the fabric.

### Example 7

The following aqueous-based ink composition was used:
Cymel 323 (Cytec Industries) 30.0 grams
Polyethylene glycol 35,000 (Sigma-Aldrich) 4.0 grams
Nacure 2501 (King Industries) 2.0 grams
Dipropylene glycol methyl ether (Dow Chemicals) 15.0 grams
Isopropanol 5.0 grams
Distilled water 40.0 grams
Spectra fix red 195 (Spectra Colors Group) 4.0 grams

A 100% cotton fabric was mounted onto the machine described above. 100% ethylene glycol butyl ether acetate (EGBEA) was uniformly applied onto an area of the cotton fabric, using a spraying nozzle, at a density of 0.60 grams per cm² area of the cotton fabric.

Immediately thereafter, while the cotton fabric was still wet with the wetting composition, an image was printed on the wet area of the fabric surface using an inkjet printing head and the ink composition described above.

The printed fabric was then subjected to curing, by heating to 150-180° C. for 180 seconds using an infrared curing unit.

Compared to a similar image printed on a similar fabric using the same print-head and ink composition, but without the pre-wetting step, the image resulting after applying the above wetting composition displayed no visible feathering signs. The optical density of the image was higher, and less ink was transferred to the back side of the fabric.

### Example 8

The following aqueous-based ink composition was used:
Cymel 323 (Cytec Industries) 30.0 grams
Polyethylene glycol 35,000 (Sigma-Aldrich) 4.0 grams
Nacure 2501 (King Industries) 2.0 grams
Dipropylene glycol methyl ether (Dow Chemicals) 15.0 grams
Isopropanol 5.0 grams
Distilled water 40.0 grams
Spectra fix red 195 (Spectra Colors Group) 4.0 grams

A 100% cotton fabric was mounted onto the machine described above. 100% cyclohexanone was uniformly applied onto an area of the cotton fabric, using a spraying nozzle, at a density of 0.60 grams per cm² area of the cotton fabric.

Immediately thereafter, while the cotton fabric was still wet with the wetting composition, an image was printed on the wet area of the fabric surface using an inkjet printing head and the ink composition described above.

The printed fabric was then subjected to curing, by heating to 150-180° C. for 180 seconds using an infrared curing unit.

Compared to a similar image printed on a similar fabric using the same print-head and ink composition, but without the pre-wetting step, the image resulting after applying the above wetting composition displayed no visible feathering signs. The optical density of the image was higher, and less ink was transferred to the back side of the fabric.

### Example 9

The following non-aqueous solvent-based ink composition was used:
Ethylene glycol butyl ether acetate (EGBEA) 80.0 grams
Cyclohexanone 4.0 grams
Dipropylene glycol methyl ether (DPM) 10.0 grams
Microlith Black preparation 6.0 grams

A 100% cotton fabric was mounted onto the machine described above. 100% ethanol was uniformly applied onto an area of the cotton fabric, using the spraying nozzle, at a density of 0.40 grams per cm² area of the cotton fabric.

Immediately thereafter, while the cotton fabric was still wet with the wetting composition, an image was printed on the wet area of the fabric surface using an inkjet printing head and the ink composition described above.

The printed fabric was then subjected to curing, as described above.

Compared to a similar image printed on a similar fabric using the same print-head and ink composition, but without the pre-wetting step, the image resulting after applying the above wetting composition displayed no visible feathering signs. The optical density of the image was higher, and less ink was transferred to the back side of the fabric.

### Example 10

The following aqueous-based ink composition was used:
Distilled water 40.0 grams
Polyethylene glycol 35,000 (Sigma-Aldrich) 4.0 grams
Dipropylene glycol methyl ether (Dow Chemicals) 15.0 grams
Cymel 323 (Cytec Industries) 30.0 grams
Nacure 2501 (King Industries) 2.0 grams
pH dependent fixation polymer 4.0 grams

A 100% black cotton fabric was mounted onto the machine described above. A mixture of 99.5% isopropanol and 0.5% formic acid was uniformly applied onto an area of the cotton fabric, using a spraying nozzle, at a density of 0.60 grams per cm² area of the cotton fabric.

Immediately thereafter, while the cotton fabric was still wet with the wetting composition, a mask of white opaque ink was printed on the area of the fabric surface using an inkjet printing head and an aqueous white ink composition.

Immediately thereafter, while the cotton fabric was still wet with the wetting composition and the white ink, an image was printed on the wet area of the fabric surface using an inkjet printing head and the ink composition described above.

The printed fabric was then subjected to curing, by heating to 150-180° C. for 180 seconds using an infrared curing unit.

Compared to a similar image printed on a similar fabric using the same print-head and ink composition, but without the pre-wetting step and without the white mask, the image resulting after applying the above wetting composition and the white mask displayed a vividly colored and sharp features with no visible feathering signs. The optical density of the image was higher, and less ink is transferred to the back side of the fabric.

### Example 11

For a quantitative assessment of the effect of the pre-wetting process using an aqueous-based wetting composition containing an exemplary property adjusting agent and aqueous-based liquid ink compositions containing an exemplary property sensitive agent. The following aqueous-based ink compositions of cyan, magenta, yellow and black colors (CMYK) formulated as bellow were used.
Water as a carrier 30-40%
Commercially available colorants such as carbon black, quinacridone, phtalocyanine and diarylide (Ciba, DuPont and BASF) as a colorant 2-4%
Johncryl HPD 96 (an acrylic resin, Johnson) as a property (pH) sensitive agent and a dispersant 3-5%
Acronal S400 (acrylic emulsion, BASF) as an adhesion promoting agent 25-30%
Propylene glycol or diethylene glycol as humectant 20-30%
Triethanol amine or diethanol amine as an organic base 0.5-1%
Sodium lauryl sulphate as a surface active agent 0.1 -0.5%
Modified siloxanes (BYK) as a defoamer 0.1-0.5%

A 100% white cotton T-shirt by Anvil was heat pressed for 3 seconds at 160° C. and mounted onto the machine (Kornit 931D).

An image composed of three rows of four squares of 4×4 cm of each color (CMYK) were printed on the media at 727×727 dots per inch in 100% coverage (first row), 75% coverage (second row) and 50% coverage (third row) of the surface per the given area and resolution.

The same color image was printed again on the same media after pre-wetting the predetermined area with a wetting composition in an amount of 0.008-0.014 grams per square centimeter:
Water as a wetting composition carrier 96.9%
Acetic acid (or formic acid or propionic acid) as a property (pH) adjusting agent 3%
Sodium lauryl sulphate as a surface active agent 0.1%

After printing the color image, the printed images were cured for 150 seconds at 150° C. using a heat press.

The optical density (OD) and Lab* values were measured on both side of the printed media, namely in the front and rear side of the fabric, using a colorimeter/densitometer Eye-One (I1) by Gretag Macbeth, used as described hereinabove.

The results are presented in Table 2 below. The left column presents the percent of area coverage by a colored ink composition at a printing coverage (100%=727×727 dots per inch), indicating whether a wetting composition was used or absent.

TABLE 2

| | | | | |
|---|---|---|---|---|
| Percent coverage | Cyan | Magenta | Yellow | Black |

Optical density
on the front of the fabric

| | | | | |
|---|---|---|---|---|
| 100% with wetting | 1.50 | 1.40 | 1.32 | 1.52 |
| 50% with wetting | 1.42 | 1.35 | 1.25 | 1.45 |
| 100% no wetting | 1.25 | 1.17 | 1.10 | 1.29 |
| 50% no wetting | 1.20 | 1.10 | 1.00 | 1.20 |

Optical density
on the back of the above prints

| | | | | |
|---|---|---|---|---|
| 100% with wetting | 0.20 | 0.22 | 0.16 | 0.25 |
| 50% with wetting | 0.15 | 0.16 | 0.12 | 0.20 |
| 100% no wetting | 0.44 | 0.47 | 0.42 | 0.50 |
| 50% no wetting | 0.30 | 0.29 | 0.27 | 0.35 |

As can be seen in Table 2, printing a colored image using the pre-wetting process yielded an optical density, corresponding to each basic color, which is overall greater on the front side of the fabric as compared to the images which were printed without using a wetting composition. As can further be seen in Table 2, the back side of the fabric was remarkably less stain with the colored ink composition when using the wetting composition.

FIG. 1 presents the rear side of a white cotton piece onto which the image was printed using a colored ink composition containing an exemplary property (pH) sensitive agent namely a resin binder that settles at low pH, but without the use of a wetting composition, and FIG. 2 presents the rear side of the same cotton piece onto which the same image was printed using the same colored ink composition subsequent to contacting the surface of the substrate with a wetting composition containing an exemplary property-adjusting agent, namely acetic acid as an organic acid for lowering the pH. As can be seen in FIG. 1, the inks penetrated the cotton fabric and left a very clear impression of the inverse image, however, as can be seen in FIG. 2, when the wetting composition comprising a pH-adjusting agent was applied, the inks comprising a property-sensitive agent hardly penetrated the fabric and the only a faint impression of the image is visible.

These results clearly demonstrate the advantageous effect of the process using a wetting composition, in combination with a property (pH)-adjusting agent that reacts with a property (pH)-sensitive agent, by showing how a high-resolution image in obtained at higher optical density per each basic color, as compared to an identical image printed without the wetting composition.

### Example 12

For a quantitative assessment of the quality of a colored image printed on a dark textile substrate with and without the use of a wetting composition containing an exemplary property-adjusting agent, the following opaque white aqueous-based liquid ink composition containing an exemplary property-sensitive agent was formulated and used:
Water as a carrier 20-30%
Titanium dioxide and calcium carbonate as a colorant 15-20%
Johncryl HPD 96 (an acrylic resin, Johnson) as a property (pH)-sensitive agent and a dispersant 5-7%
Acronal S400 (acrylic emulsion, BASF) as an adhesion promoting agent 22-30%
Propylene glycol or diethylene glycol as a humectant 20-30%
Glycol ether (such as dipropylene glycol ether, tripropylene glycol ether or methoxy propanol) as an organic solvent: 2-4%
Triethanol amine or diethanol amine as an organic base 0.5-1%
Sodium lauryl sulphate as a surface active agent 0.0-0.3%
Modified siloxanes (BYK) as a defoamer 0.1-0.5%;
   and the same aqueous-based CMYK colored liquid ink composition used in the previous example were used:

A black 100% cotton T-shirt (Beefy-T) by Hanes was heat pressed for 3 seconds at 160° C. and mounted onto the machine (Kornit 931D).

A matrix of 3×4 squares, each of 4×4 centimeters, matching the color image used in the previous example, was printed on the media at a resolution of 636×454 dots per inch and 100% area coverage using the opaque white ink composition. Immediately thereafter, and without curing the white ink layer, the image of the colored aqueous-based liquid ink compositions of the CMYK inks was printed at the exact area of the previously printed white mask at a resolution of 636 454 dots per inch in 100% coverage (first row), 75% coverage (second row) and 50% coverage (third row) of the surface per the given area and resolution.

The same color image was printed again on the same media after pre-wetting the predetermined area with the same wetting composition containing the exemplary property adjusting agent used in Example 11 hereinabove in an amount of 0.025-0.032 grams per square centimeter, using the same wetting composition as in the previous example.

The printed images were subsequently cured for 150 seconds at 150° C. using hot air drier.

The optical density (OD) and Lab* values were measured on both side of the printed media, namely in the front and rear side of the fabric, using a colorimeter/densitometer Eye-One (I1) by Gretag Macbeth, used as described hereinabove.

The results of the color prints on a black fabric, printed with or without a pre-wetting process at a printing resolution of 636×454 dots per inch, printed on two layers of an opaque white ink composition are presented in Table 3 below. The Δ(ΔE) values are calculated relatively to the Lab* values measured for the color of the black fabric itself without any ink thereon.

TABLE 3

| | C | | | M | | | Y | | | Black fabric | | |
|---|---|---|---|---|---|---|---|---|---|---|---|---|
| Printing process | L | A | B | L | A | B | L | A | B | L | A | B |
| No treatment or | — | — | — | — | — | — | — | — | — | 16 | 1.6 | −0.1 |
| ink | | | | | | | | | | | | |
| 100% with | 42.8 | −10 | −46.6 | 36.8 | 53.3 | 13.4 | 82.7 | −0.2 | 83 | — | — | — |
| wetting | | | | | | | | | | | | |
| 100% no | 21.2 | −2.4 | −8.4 | 18.5 | 6.2 | −4 | 21.7 | −1.1 | 3 | — | — | — |
| wetting | | | | | | | | | | | | |

| | | | |
|---|---|---|---|
| ΔE with wetting | 33.9 | 28.8 | 73.1 |
| ΔE no wetting | 9.7 | 6.5 | 6.2 |
| Δ(ΔE) | 24.2 | 22.3 | 66.9 |

As can be seen in Table 3, providing a white background to the colored image practically enables the image to be seen over the black surface, and even in excellent color quality and accuracy of the hue. As in the previous example, again here the use of a wetting composition greatly improves the quality of the printed color image. It should be noted that a change of 5 ΔE is a remarkable change and a change of 20 ΔE is an enormous improvement of the quality of the colors.

FIG. 3 presents the front side of a black cotton piece onto which an opaque white mask and a color image were printed without the use of a wetting composition prior to applying the opaque white liquid ink composition, wherein both liquid ink compositions contained an exemplary property-sensitive agent. FIG. 4 presents the front side of the same cotton piece onto which the same white mask and the same image, were printed subsequent to applying the wetting composition which contained an exemplary property-adjusting agent. As can be seen in FIG. 3, the colors appear dull and with little distinction between the various printing coverage (row-wise), however, as can be seen in FIG. 4, when the wetting composition was applied, the colors on the image appear vividly and the various coverage are clearly distinguishable.

### Example 13

For a quantitative assessment of the effect of the pre-wetting process on a dark textile substrate, two layers of the colored aqueous-based ink compositions having a property sensitive agent used in the previous example were used on the same type of black T-shirt but without printing a layer of a white ink composition. The wetting composition having a property adjusting agent used is identical to the wetting composition used in the previous example.

The image was composed of two rows of five colors, namely white, black, yellow, magenta and cyan. The upper row was printed at a 100% coverage (100%=636×454 dpi) and the lower row was printed at a 50% coverage.

The same image was printed once with the use of a wetting composition and one without the wetting composition.

The results of the color prints on a black fabric, printed with a pre-wetting process at a printing resolution of 636×454 dots per inch, printed in two layers of the colored ink compositions are presented in Table 4 below. The Δ(ΔE) values are calculated relatively to the Lab* values measured for the color of the black fabric itself without any ink thereon.

TABLE 4

| | Cyan | | | Magenta | | | Yellow | | | White | | |
|---|---|---|---|---|---|---|---|---|---|---|---|---|
| | L | A | B | L | A | B | L | A | B | L | A | B |
| 100% | 22 | 9 | −17 | 26 | 19 | 6 | 43 | −11.5 | 27 | 74 | −2.5 | −1.5 |
| with | | | | | | | | | | | | |
| wetting | | | | | | | | | | | | |
| 50% with | 17 | 6 | −12 | 19 | 12 | 2 | 31 | −8.5 | 14 | 59 | −2 | −3.5 |
| wetting | | | | | | | | | | | | |
| ΔE at 100% | | 13.1 | | | 17.3 | | | 30.7 | | | 56 | |
| ΔE at 50% | | 9 | | | 11.5 | | | 20 | | | 37 | |

As can be seen in Table 4, pre-wetting the substrate prior to printing the colored image practically enables the image to be seen over the black surface although in skewed colors, even in 50% printing coverage. As in the previous example, again here the use of a wetting composition greatly improves the quality of the printed color image even without the use of a white mask background. It should be noted that the ΔE observed for all colors, and particularly for the bright colors, yellow and white, is a remarkable improvement of the quality of the colors even at these unfavorable conditions.

The results of the color prints on a black fabric, printed without a pre-wetting process at a similar printing resolution of 636×454 dots per inch, printed in two layers of the colored ink compositions are presented in Table 5 below. The Δ(ΔE) values are calculated relatively to the Lab* values measured for the color of the black fabric itself without any ink thereon.

TABLE 5

| | Cyan | | | Magenta | | | Yellow | | | White | | |
|---|---|---|---|---|---|---|---|---|---|---|---|---|
| | L | A | B | L | A | B | L | A | B | L | A | B |
| 100% without | 13 | 2 | −4.5 | 15 | 6.5 | 0 | 17 | −1 | 1.2 | 24.5 | 0.5 | −4 |
| wetting | | | | | | | | | | | | |
| 50% without | 13.5 | 1.8 | −5 | 14 | 5.3 | 0 | 18 | −2 | 2.5 | 27.5 | 0 | −5 |
| wetting | | | | | | | | | | | | |
| ΔE at 100% | | 3.3 | | | 4.7 | | | 4 | | | 10 | |
| ΔE at 50% | | 3.5 | | | 4 | | | 6 | | | 13 | |

As can be seen in Table 5, by not providing a wetting composition on the substrate prior to printing the colored image practically, the image is hardly seen over the black surface even in 100% printing coverage. This result clearly shows the importance of the pre-wetting process.

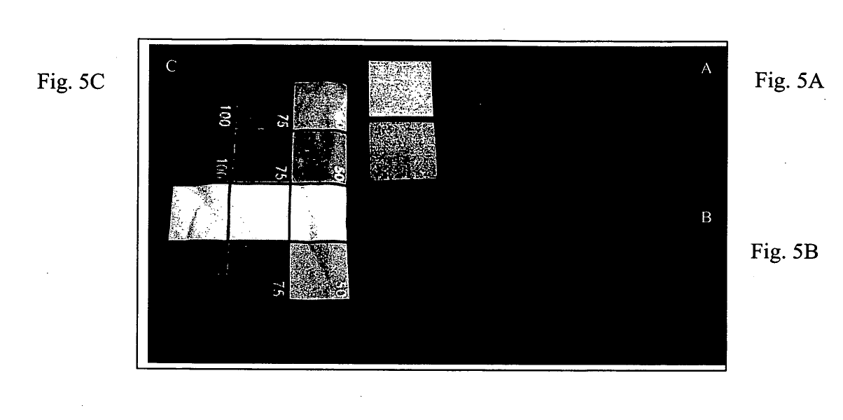

FIGS. 5a-5c presents photographs showing three substrates treated as described above so as to compare the results of Example 12 with the results of Example 13. In FIG. 5a the two rows of colored squares are the results of printing the colored ink compositions containing a property-sensitive agent in two layers at a 100% coverage (top row) and 50% coverage (bottom row), both after applying the wetting composition containing a property-adjusting agent. In FIG. 5b the two rows of colored squares are the results of printing the same colored ink compositions in two layers at a 100% coverage (the) and 50% coverage (the), but without applying a wetting composition. FIG. 5c shows the results from Example 12 above, wherein a similar color image was printed on top of a white masking layer containing a property-sensitive agent using of a wetting composition containing a property-adjusting agent. As can be seen in FIGS. 5a-5b, the use of the wetting composition and harnessing the effect of using a property-sensitive and adjusting agents has a great effect on the visibility of a colored image, even when printed with transparent ink compositions as compared to the image printed on a dry substrate, yet the most striking result, shown in FIG. 5c, is clearly obtained when both a wetting composition containing a property-adjusting agent and a white masking layer containing a property-sensitive agent are applied onto the surface of the substrate prior to printing the color image using colored liquid ink compositions which also contain a property-sensitive agent.

Overview of the Results:

The quality tests performed for the color prints on white and dark textile pieces, obtained by the processes presented herein, show clearly that when liquid color inkjet compositions containing a property-sensitive agent are printed on a suitably pre-wetted surface with a wetting composition which contains a property-adjusting agent, the resulting colors are greatly improved with respect to colors printed under similar condition without the pre-wetting process, according to measurements of quality parameters which are widely used in the art, regardless of the color of the media.

Color measurements of Lab*, optical density and DeltaE (ΔE) values clearly show that all colors, namely cyan, magenta, yellow and black, give remarkably superior color qualities with respect to color definition and saturation as compared to standard reference colors. The results measured for these criteria signify a wider and more complete color space (gamut), a higher achievable color contrast and a wider dynamic color range, which is obtained in a multicolor image printed as presented herein on a textile piece of any color and shade.

One particular parameter which is greatly improved by applying a wetting composition is the optical density which can be achieved. The reflectance from the printed liquid inkjet compositions on a pre-wetted surface is more varied, meaning that a higher contrast and a deeper/stronger color can be achieved on various media types, and particularly on textile pieces of any color or shade.

Another finding stemming from the measurements presented herein in the fact that a notable higher color optical density can be achieved on textile using a smaller amount of liquid ink composition. It is evident that due to the pre-wetting process ink composition can be saved up to 50% the amount of ink without sacrificing the quality of the multicolor image and even improving it. The results presented above further show that after applying the pre-wetting composition, much less ink passes through the media to the back side thereof, and again less ink is consumed and wasted.

Finally, another finding stemming from the experimental results presented hereinabove, is that the extent of the effect of using a wetting composition containing a property-adjusting agent with a transparent colored ink composition containing an property-sensitive agent, goes beyond the extent of the effect of using an opaque white mask under a color image without the use of a wetting composition. In other words, the wetting process in combination with the property-sensitive and adjusting agents afforded a visible color image made of layers of transparent color inks over a black and absorptive surface (black cotton T-shirt) by virtue of affixing the droplets of colored ink on top of the fabric until the ink dried or cured, leaving a semi-opaque colored layer constituting the color image.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A process of printing a color image on a dark surface, the process comprising:
digitally printing, by means of an inkjet printing head, a layer of a substantially opaque liquid ink composition onto the dark surface; and
digitally printing a colored liquid ink composition on said layer of said opaque liquid ink composition, to thereby form the color image,
wherein said opaque liquid ink composition is capable of modifying a light interaction of the image.

2. The process of claim 1, wherein digitally printing said layer of said opaque liquid ink composition is performed such that said layer of said opaque liquid ink composition substantially covers, without exceeding, the designed area of said colored image.

3. The process of claim 1, wherein said printing is performed such that said layer of said opaque liquid ink composition and said color image are substantially coextensive.

4. The process of claim 1, wherein digitally printing the color image is performed without curing said layer of said opaque liquid ink composition.

5. The process of claim 1, wherein said opaque liquid ink composition is a lightly colored ink composition.

6. The process of claim 5, wherein said opaque liquid ink composition is a substantially white ink composition.

7. The process of claim 1, wherein digitally printing said layer of said opaque liquid ink composition is effected prior to, concomitant with and/or subsequent to said digitally printing said colored liquid ink composition.

8. The process of claim 1, wherein each of said opaque liquid ink composition and said colored liquid ink composition independently comprises a colorant and a carrier.

9. The process of claim 8, wherein said carrier is an aqueous carrier.

10. The process of claim 8, wherein a concentration of said colorant ranges from 0 weight percentages to about 10 weight percentages of the total weight of said composition.

11. The process of claim 8, wherein a concentration of said colorant ranges from about 10 weight percentages to about 25 weight percentages of the total weight of said composition

12. The process of claim 8, wherein each of said opaque liquid ink composition and said colored liquid ink composition, independently, further comprises an additional component selected from the group consisting of an adhesion promoting agent, a viscosity modifying agent, a dispersing agent, a thickening agent, a surface active agent, a surfactant, a polyol, a surface tension modifying agent, a softener, and any combination thereof.

13. The process of claim 1, wherein at least one of said opaque liquid ink composition and said colored liquid ink composition comprises a property-adjusting agent and at least one of said opaque liquid ink composition and said colored liquid ink composition which does not comprise said property-adjusting agent comprises a property-sensitive agent, whereas said property-adjusting agent effects a chemical and/or physical change in said property-sensitive agent upon a contact between said opaque liquid ink composition and said colored ink composition, and thereby effects a chemical and/or physical change in said opaque liquid ink composition or said colored liquid ink composition which comprises said property-sensitive agent.

14. The process of claim 13, wherein said opaque liquid ink composition comprises said property-adjusting agent and said colored liquid ink composition comprises said property-sensitive agent, such that contacting said opaque liquid ink composition and said colored liquid ink composition effects a chemical and/or physical change in said colored liquid ink composition.

15. The process of claim 13, wherein said chemical and/or physical change is selected from the group consisting of solidification, adhesion, thickening, polymerization, sedimentation and cross-linking.

16. The process of claim 13, wherein said property is a chemical and/or physical property selected from the group consisting of acidity (pH), ionic strength, solubility, hydrophobicity and electric charge.

17. The process of claim 13, wherein said property-adjusting agent is selected from the group consisting of an acid, a base, a salt, a charged polymer, an oxidizing agent, a reducing agent, a radical-producing agent and a cross-linking agent.

18. The process of claim 13, wherein said chemical and/or physical property is acidity.

19. The process of claim 18, wherein said property-adjusting agent is an organic acid.

20. The process of claim 13, wherein said property-sensitive agent is selected from the group consisting of an adhesion promoting agent, a dispersing agent, a viscosity modifying agent, a thickener agent, a surface tension modifying agent, a surface active agent, a surfactant and a softener.

21. The process of claim 17, wherein a concentration of said property-adjusting agent ranges from about 0.5 weight percentages to about 20 weight percentages of the total weight of the composition comprising same.

22. The process of claim 20, wherein a concentration of said property-sensitive agent ranges from about 0.5 weight percentages to about 30 weight percentages of the total weight of the composition comprising same.

23. A process of printing a color image on a dark surface, the process comprising:
contacting at least a part of the surface with a wetting composition so as to provide a wet part of said surface;
digitally printing, by means of an inkjet printing head, a layer of a substantially opaque liquid ink composition directly onto the dark surface; and
digitally printing a colored liquid ink composition on said layer of said opaque liquid ink composition and/or said wetting composition, to thereby form the color image,
wherein:
said wetting composition is capable of modifying an interaction of said opaque liquid ink composition with the surface and/or said wetting composition is capable of modifying an interaction of said colored liquid ink composition with the surface and/or with said opaque liquid ink composition; and
said opaque liquid ink composition is capable of modifying a light interaction of the image.

24. The process of claim 23, wherein digitally printing said layer of said opaque liquid ink composition is performed such that said layer of said opaque liquid ink composition substantially covers, without exceeding, the designed area of said colored image.

25. The process of claim 23, wherein said printing is performed such that said layer of said opaque liquid ink composition and said color image are substantially coextensive.

26. The process of claim 23, wherein said digitally printing the color image is performed without curing said wetting composition and/or said layer of said opaque liquid ink composition.

27. The process of claim 23, wherein digitally printing said opaque liquid ink composition is effected prior to, concomitant with and/or subsequent to said digitally printing said colored liquid ink composition.

28. The process of claim 23, wherein said contacting is effected prior to, concomitant with and/or subsequent to said digitally printing said opaque liquid ink composition.

29. The process of claim 23, wherein said contacting is effected prior to, concomitant with and/or subsequent to said digitally printing said colored liquid ink composition.

30. The process of claim 23, wherein said opaque liquid ink composition is a lightly colored ink composition.

31. The process of claim 30, wherein said opaque liquid ink composition is a substantially white ink composition.

32. The process of claim 23, wherein each of said opaque liquid ink composition and said colored liquid ink composition independently comprises a carrier and a colorant.

33. The process of claim 32, wherein said carrier is an aqueous carrier.

34. The process of claim 32, wherein each of said opaque liquid ink composition and said colored liquid ink composition independently further comprises an additional component selected from the group consisting of an adhesion promoting agent, a viscosity modifying agent, a dispersing agent, a thickener agent, a surface active agent, a surfactant, a polyol, a surface tension modifying agent, a softener and any combination thereof.

35. The process of claim 23, wherein said wetting composition comprises an organic solvent.

36. The process of claim 35, wherein said wetting composition further comprises water.

37. The process of claim 23, wherein at least one of said opaque liquid ink composition, said colored liquid ink composition and said wetting composition comprises a property-adjusting agent and at least one of said opaque liquid ink composition, said colored liquid ink composition and said wetting composition which does not comprise said property-adjusting agent comprises a property-sensitive agent, whereas said property-adjusting agent effects a chemical and/or physical change in said property-sensitive agent upon contacting said composition which comprises said property-sensitive agent and said composition which comprises said property-sensitive agent, and thereby effects a chemical and/or physical change in said wetting composition, said opaque liquid ink composition and/or said colored liquid ink composition which comprises said property-sensitive agent.

38. The process of claim 37, wherein at least one of said opaque liquid ink composition and said colored liquid ink composition comprises said property-sensitive agent and said wetting composition comprises said property-adjusting agent.

39. The process of claim 37, wherein said chemical and/or physical change is selected from the group consisting of solidification, adhesion, thickening, polymerization, sedimentation and cross-linking.

40. The process of claim 37, wherein said property is a chemical and/or physical property selected from the group consisting of acidity (pH), ionic strength, solubility, hydrophobicity and electric charge.

41. The process of claim 37, wherein said property-adjusting agent is selected from the group consisting of an acid, a base, a salt, a charged polymer, an oxidizing agent, a reducing agent, a radical-producing agent and a cross-linking agent.

42. The process of claim 40, wherein said property is acidity.

43. The process of claim 42, wherein said property-adjusting agent is an organic acid.

44. The process of claim 37, wherein said property-sensitive agent is selected from the group consisting of an adhesion promoting agent, a dispersing agent, a viscosity modifying agent, a thickener agent, a surface tension modifying agent, a surface active agent, a surfactant and a softener.

45. The process of claim 23, wherein said wetting composition is characterized by a surface tension lower than a surface tension of each of said opaque and colored liquid ink composition.

46. The process of claim 45, wherein said surface tension of said wetting composition is lower than said surface tension of each of said opaque and colored liquid ink composition by at least 2 dynes per centimeter.

47. A dark substrate having an image printed on a surface thereof, prepared by the process of claim 1.

48. A dark substrate having an image printed on a surface thereof, prepared by the process of claim 23.

49. The substrate of claim 48, wherein said image is characterized by wide and continuous L*a*b* color space, high optical density, high color definition, high resolution, no color bleeding, high durability, chemical-fastness and/or wash-fastness.
